(19) United States
(12) Patent Application Publication
(10) Pub. No.: US 2017/0034357 A1
(43) Pub. Date: Feb. 2, 2017

(54) Systems and Methods for Making Low-Cost International Phone Calls

(71) Applicant: PassportPhone LLC, Dallas, TX (US)

(72) Inventors: Oren Salomon, Dallas, TX (US); Geoffrey Byers, Dallas, TX (US); Sean Meador, Dallas, TX (US)

(21) Appl. No.: 15/224,216

(22) Filed: Jul. 29, 2016

Related U.S. Application Data
(60) Provisional application No. 62/199,201, filed on Jul. 30, 2015.

(51) Int. Cl. H04M 7/00; H04M 3/42; H04L 29/12; H04M 7/12

(52) U.S. Cl. CPC H04M 7/0006; H04M 7/1205; H04M 7/0066; H04M 7/125; H04M 3/42042; H04L 61/605; H04L 61/106

(57) ABSTRACT

Various embodiments are described herein that relate to computer hardware and programs for facilitating international calls between individuals. More specifically, an international call system can route voice traffic between multiple telephone network endpoints. For example, a client application (also referred to as a “client”) may be accessed by a traveler on a mobile phone. The client can be configured to connect to a network-accessible application server, which can communicate with a call processing system that routes voice traffic from the traveler's mobile phone to the mobile phone of a desired contact (and, in some embodiments, vice versa). The international call system described herein makes use of the local providers in each country traversed by the traveler. Consequently, low-cost calling can be enabled in both directions, while predictable reachability is guaranteed as the traveler moves between different local providers.

### CROSS-REFERENCE TO RELATED APPLICATIONS

This application claims the benefit of U.S. Provisional Application Ser. No. 62/199,201 filed Jul. 30, 2016, and titled “System and Method for Making Low-Cost International Phone Calls,” the entirety of which is incorporated herein by this reference thereto.

### TECHNICAL FIELD

Various embodiments concern computer-implemented techniques for facilitating international calls and, more specifically, software applications and/or hardware appliances that route voice traffic between multiple telephone network endpoints.

### BACKGROUND

The public switched telephone network (PSTN) is the aggregate of the world's circuit-switched telephone networks that are operated by national, regional, or local telephony operators, The PSTN includes telephone lines, fiber optic cables, cellular networks, communications satellites, and undersea telephone cables that are interconnected by switching centers. The PSTN provides the infrastructure and services for public telecommunication and allows most telephones to seamlessly communicate with one another.

But keeping connected via voice on the PSTN is often difficult for international travelers who are faced with poor alternatives: (1) use one or more local wireless providers for the intended destination; or (2) use international roaming supported by their primary wireless provider. Problems accompany each of these alternatives. For example, a traveler will be forced to use a phone number that is unknown to those individuals the traveler is attempting to contact when using a local wireless provider, while the traveler may be charged exorbitant fees when using his or her primary wireless provider. Moreover, the former option may have elevated outbound international calling per-minute rates (for the traveler and those he or she attempts to contact) that negatively impact cost savings when compared to traditional international roaming.

### BRIEF DESCRIPTION OF THE DRAWINGS

Various objects, features, and characteristics will become apparent to those skilled in the art from a study of the Detailed Description in conjunction with the appended claims and drawings, all of which form a part of this specification. While the accompanying drawings include illustrations of various embodiments, the drawings are not intended to limit the claimed subject matter.

FIG. 1 depicts a generalized illustration of a network environment that includes an international call system that enables callers to realize the advantages of both the PSTN (e.g., reliability) and local carriers (e.g., low cost).

FIG. 2 depicts a generalized illustration of a network environment that includes an international call system and supporting infrastructure.

FIG. 3 depicts a client that accesses a calling service made available by an international call system.

FIG. 4 depicts a generalized illustration of a network environment that includes an application server capable of executing an API module.

FIG. 5 illustrates how the connection logic service may be a component of the API module that resides on the application server.

FIG. 6 illustrates how the connection logic service module can handle inbound Hypertext Transfer Protocol (HTTP) requests.

FIG. 7 depicts a generalized illustration of a network environment that includes a call processing system interconnected with other components of an international call system.

FIG. 8 illustrates how a Voice over IP (VoIP) module can handle inbound HTTP requests from an application server.

FIG. 9 depicts a generalized illustration of the network interconnections between an application server, a VoIP services API module, and multiple mobile phones operated by users who intend to communicate with one another.

FIG. 10 depicts a flow diagram of a process for making low-cost international calls.

FIG. 11 depicts a flow diagram of a process for swapping SIM cards, thereby enabling the user (e.g., a traveler) to complete low-cost international calls from multiple countries.

FIG. 12A-L depict a series of interfaces that illustrate these processes (e.g., the processes of FIGS. 10-12) from a user's perspective.

FIG. 13 depicts how setting up a database for storing phone numbers may require completion of multiple steps.

FIG. 14 depicts a flow diagram showing the actions of the user, as well as the associated communication among components of the international call system and the supporting infrastructure.

FIG. 15 depicts a flow diagram of a process for adding a contact to the international call system.

FIG. 16 depicts an exemplary bridge that includes four phone numbers and associated metadata.

FIG. 17 is a schematic diagram illustrating the roles that the active local number, access number, callback number, and destination number play in routing calls placed between a user and a contact.

FIG. 18 includes an entity-relationship chart that shows how a bridge data structure could be stored in a relational database.

FIG. 19A-E depict a flow diagram of a process for creating a bridge for a new contact.

FIG. 20 depicts a process for exploiting the international call system described herein to place a low-cost call from a user in one country to a contact in another country.

FIG. 21 depicts the life cycle of an HTTP request initiated by the VoIP services API module and received by the connection logic service module's InboundAction endpoint within the API module residing on the application server.

FIG. 22 depicts a bridge retrieval process by which a “From” number and a “To” number are resolved into a bridge, along with associated information on how to route the other leg of the call.

FIG. 23 depicts a process in which a contact returns a call to a user.

FIG. 24 is a block diagram illustrating an example of a processing system in which at least some of the operations described herein can be implemented.

FIGS. 25A-E provide selections of example PHP code for the API module supporting the operation of the application server.

The figures depict various embodiments described throughout the Detailed Description for the purposes of illustration only. While specific embodiments have been shown by way of example in the drawings and are described in detail below, the invention is amenable to various modifications and alternative forms. The intention is not to limit the invention to the particular embodiments described herein. Accordingly, the claimed subject matter is intended to cover all modifications, equivalents, and alternatives falling within the scope of the invention as defined by the appended claims.

### DETAILED DESCRIPTION

Various embodiments are described herein that relate to computer hardware and programs for facilitating international calls between individuals. More specifically, an international call system can route voice traffic between multiple telephone network endpoints. For example, a client application (also referred to as a “client”) may be accessed by a traveler on a mobile phone. The client could be accessible as a standalone mobile application, a website, or some other means (e.g., via Short Messaging Service (SMS) or email). The client application is configured to connect to a network-accessible application server, which can communicate with a call processing system that routes voice traffic from the traveler's mobile phone to the mobile phone of a desired contact (and, preferably, vice versa).

The international call system may provide a consistent return path for the desired contact to reach the traveler, even as the phone number associated with the traveler changes from country to country. Note that, for purposes of discussion here, the term “country” may refer to a geographic area assigned with a specific telephone country code. Moreover, the international call system may not require a certain application be executed on the desired contact's mobile phone. The desired contact may instead simply be able to complete a call to, or receive a call from, a local access number associated with a connection to the traveler.

The international call system described herein makes use of the local providers in each country traversed by the traveler (and thus keeps costs low). Thus, low-cost calling can be enabled in both directions, while predictable reachability is guaranteed as the traveler moves between different local providers. These benefits are possible despite the international call system continuing to also make use of the (generally more reliable) PSTN for the termini of the voice call, rather than an end-to-end VoIP solution,

Several exemplary use cases highlight the advantages of such a system:

Primary Use Case
Travelers going abroad who seek to dial and receive phone calls from countries other than where they are currently residing.

Secondary Use Cases
Expatriates permanently or semi-permanently residing in another country that seek to dial and receive phone calls from countries other than where they are currently residing.
Two individuals residing in different countries who seek to dial and receive phone calls from one another, whether for business or personal reasons.
A third party seeks to provide international calling at local rates for at least two other parties (e.g., a charity providing call bridges to those affected in an emergency with relief efforts or a school providing call bridges for study abroad students and their parents).
Any of the above use cases being used for state/province/regional long-distance calling as opposed to international long-distance calling.

Various embodiments may be described with reference to particular system configurations (e.g., mobile phones operated by the user and the contact) and networks. However, one skilled in the art will recognize that the features and techniques described herein may be equally applicable to other system configurations, network, types, etc. Moreover, the techniques introduced herein could be embodied as special-purpose hardware (e.g., circuitry), circuitry programmed with software and/or firmware, or a combination of special-purpose hardware and programmable circuitry. Hence, embodiments may include a machine-readable medium having instructions stored thereon that can be used to program a computer (or some other computing device) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or any other type of media/machine-readable medium suitable for storing electronic instructions.

### TERMINOLOGY

Brief definitions of terms, abbreviations, and phrases used throughout the Detailed Description are given below.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not others.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. For example, two devices may be coupled directly, or via one or more intermediary channels or devices. As another example, devices may be coupled in such a way that information can be passed there between, while not sharing any physical connection with one another. Additionally, the words “herein,” “above,” “below,” and words of similar import, when used in this application, shall refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

If the specification states a component or feature “may,” “can,” “could,” or “might” be included or have a characteristic, that particular component or feature is not required to be included or have the characteristic.

The term “module” refers broadly to software, hardware, or firmware (or any combination thereof) components. Modules are typically functional components that can generate useful data or other output using specified input(s). A module may or may not be self-contained. An application program (also called an “application”) may include one or more modules, or a module can include one or more application programs.

The terminology used in the Detailed Description is intended to be interpreted in its broadest reasonable manner, even though it is being used in conjunction with certain examples. The terms used in this specification generally have their ordinary meanings in the art, within the context of the disclosure, and in the specific context where each term is used. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, and special significance is not to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

### System Topology Overview

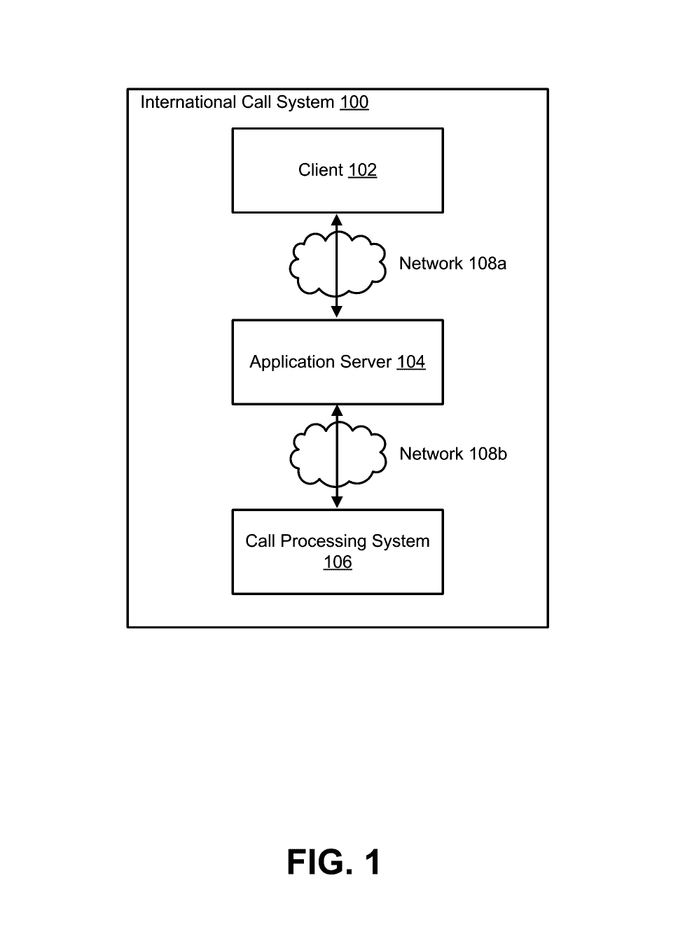

FIG. 1 depicts a generalized illustration of a network environment that includes an international call system 100 that enables callers to realize the advantages of both the PSTN (e.g., reliability) and local carriers (e.g., low cost). Although many examples provided herein specify that the caller is a traveler in a foreign country, one skilled in the art will recognize that the international call system may be used advantageously by others as well.

The international call system includes three main components: a client 102, an application server 104, and a call processing system 106. One or more networks 108a-b connect the client 102 to the application server 104, and the application server 104 to the call processing system 106. The networks 108a-b could be, for example, the Internet or a cellular network.

The client 102 is a client-side interface with which the traveler interacts. For example, the client 102 may be executed by the operating system of the traveler's device (e.g., a mobile phone, tablet, or laptop). The call processing system 106, meanwhile, has Public Switch Telephone Network (PSTN) access in both the traveler's current country and the countries of the contacts the traveler wishes to communicate with.

The application server 104 interacts directly with (and serves as an interface between) the client 102 and the call processing system 106. More specifically, the application server can identify appropriate number routing policies, apply those number routing policies, and perform various other traveler account-related activities (e.g., maintain a list of contacts across multiple traveler devices).

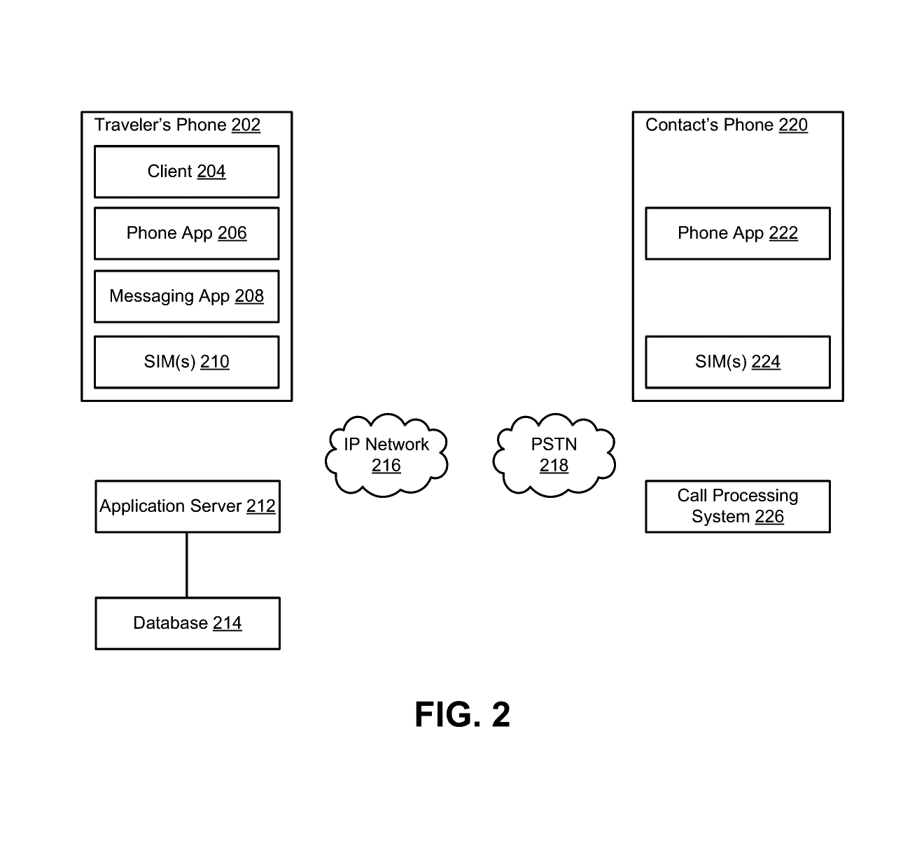

FIG. 2 depicts a generalized illustration of a network environment that includes an international call system and supporting infrastructure. Together, the international call system and supporting infrastructure facilitate the placement of international calls by routing voice traffic between multiple PSTN endpoints (e.g., a traveler's mobile phone 202 and a contact's mobile phone 220).

As shown in FIG. 2, a client 204 resides on the mobile phone of each user of the international call system (i.e., every person who intends to use the international call system to initiate calls). The client 204 acts as client-side interface for utilizing a call processing system 226 that has PSTN access in multiple countries or regions. The traveler's mobile phone 202 may also include a (conventional) phone application 206 for placing and receiving calls over the PSTN, a (conventional) messaging application 208 for sending and receiving text messages (e.g., SMS-based messages), and a subscriber identification module (SIM) card 210. The SIM card 210 is an integrated circuit chip that is intended to securely store information associated with the traveler, such as an international mobile subscriber identity (IMSI) number and its related key, which can be used to identify and authenticate the mobile phone. The SIM card 210 could also include stored contact information. Neither the phone application 206 nor the messaging application 208 generally need to be specialized for use with the client 204.

As noted above, the client 204 communicates with a call processing system 226 via an application server 212. Such communication may occur across one or more networks, such as an Internet Protocol (IP) network 216 or the PSTN 218. Moreover, in some embodiments the application server 212 is connected to a database 214 that provides storage capabilities for the application server 212. For example, the database 214 could include assignable local telephone numbers, user information, instructions for implementing the operations described herein, etc.

The call processing system 226 enables the traveler's mobile phone 202 to place a call to a contact's mobile phone 220. The contact's mobile phone 220 can also include a (conventional) phone application 222 and a SIM card 224. The phone application 222 allows the contact (i.e., the person to whom the traveler has placed a call) to receive any calls placed by devices connected to the PSTN 218. The contact's mobile phone 220 need not necessarily include a client if the contact is only interested in receiving, rather than placing, international calls.

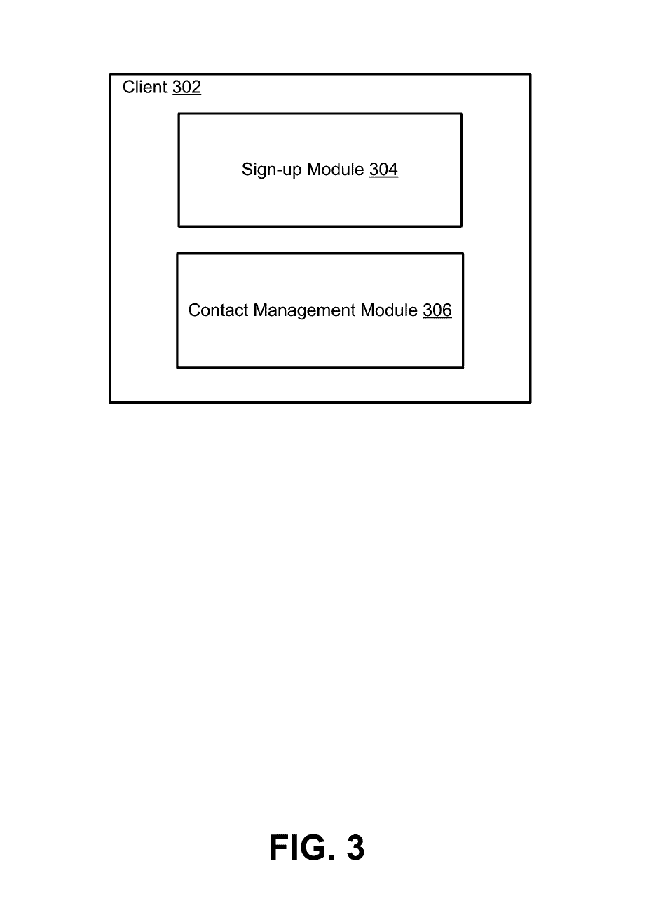

FIG. 3 depicts a client 302 that accesses a calling service made available by an international call system. The client 302 represents a client-side interface (also referred to as a “user-side interface”) that resides on the traveler's mobile phone. For example, the client 302 may take the form of a mobile application developed for an Apple iOS or Google Android operating system. Alternative embodiments may include a hybrid web/native application (e.g., via Apache Cordova), a mobile-friendly or desktop-friendly web site, a native desktop application, an over-the-top (OTT) application, or an SMS-based interface. Accordingly, the client 302 can be supported by computer hardware, firmware, software, or some combination thereof.

The client 302 can include numerous modules for facilitating the placement of international calls. Here, for example, the client 302 includes a sign-up module 304 and a contact management module 306. The sign-up module 304 provides a means for a user (e.g., a traveler) to direct the international call system and interact with it to perform preliminary activities that make it possible to place and receive low-cost international calls. The sign-up module 304 may also be responsible for processing and storing registration information provided by the user during a registration process. The registration information could be input by the user into one or more interfaces shown by the client 302. The contact management module 306 may maintain a list of contacts that the user can communicate with via the international call system. Moreover, the contact management module 306 may enable the user to add and delete contacts from the list and place calls to the contacts within the list.

As shown in FIGS. 1-2, the client 302 is linked to an application server via a network, such as an IP network. All communications between the client 302 and the application server are preferably transmitted over a secure, encrypted channel (e.g., HyperText Transfer Protocol Secure (HTTPS) with Transport Layer Security (TLS) or TLS alone). Alternatively, communication may be unencrypted, with or without a digital signature attached to each block of communicated data to ensure its authenticity. Unencrypted communication may be necessary in the case of more primitive communication methods, such as SMS.

Communication between the client 302 and the application server preferably transpires over standard protocols and data formats (e.g., a Representational State Transfer (REST) API over HTTPS with JavaScript Object Notation (JSON) request and response payloads). However, other embodiments may use other data protocols, such as a Simple Object Access Protocol (SOAP) over HTTP application with Extensible Markup Language (XML), or a binary format transmitted directly over Transmission Control Protocol (TCP), provided the client 302 on a standard mobile provider can interact with the application server over SMS or the provider's data network.

In some embodiments, the user is initially authenticated between the client 302 and the application via a primary credential (e.g., an email address) and one or both of a fixed secondary credential (e.g., a password or passphrase) and a variable secondary credential (e.g., a time-based or event-based one-time password). Once initially authenticated, users (e.g., travelers) can be provided with a time-limited token that the client 302 uses to authenticate additional interactions with the international call system. In some embodiments, travelers are also provided a less strictly limited token (e.g., one that is not time limited) that is used in place of the original credentials to acquire new time-limited tokens once the current token expires. One example of such an authentication system is OAuth 2.0, which is an open standard for authorization flows for web applications, desktop applications, mobile phones, etc.

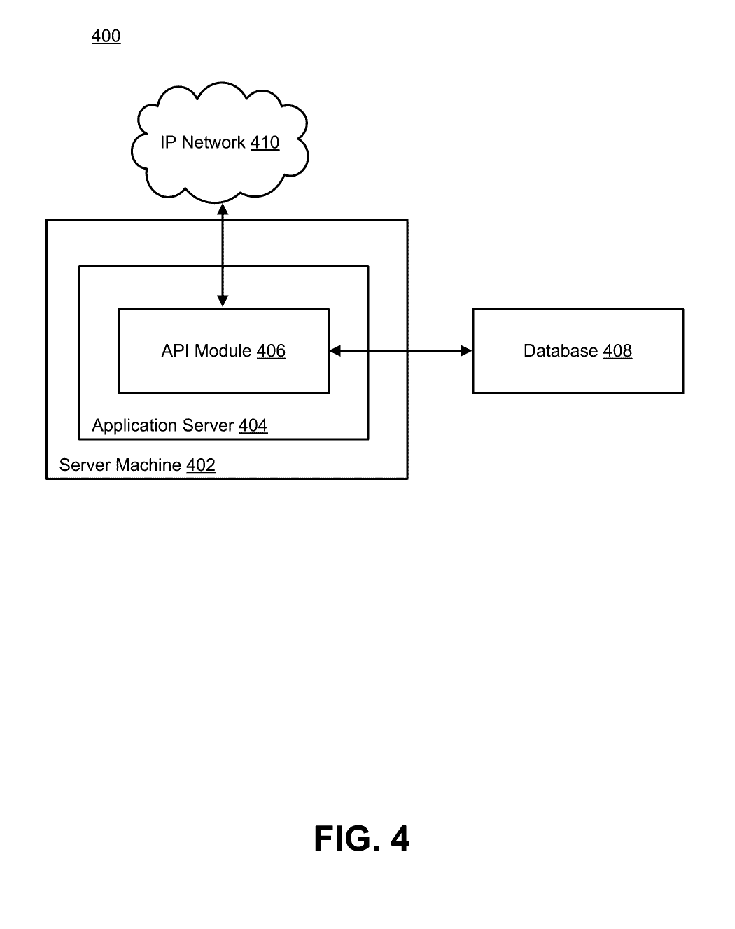

FIG. 4 depicts a generalized illustration of a network environment 400 that includes an application server 404 capable of executing an API module 406. The application server 404 can reside on a conventional server machine 402 and may be linked to an IP network 410 and/or a database 408.

The application server 404 can include an API module 406 that comprises endpoints and business logic in a conventional architecture for facilitating operation of the international call system. In some embodiments, the application server 404 calls for a conventional web application server exposing an API over HTTPS and persisting information on users of the international call system, such as users' local numbers (i.e., phone numbers associated with SIMs installed in users' phones), users' contacts, and users' contact call routing bridges in a relational database (e.g., database 408).

The web application may reside on the same hardware as the database 408, or it may exist on one or more pieces of hardware dedicated to serving the web application with the database 408 on a separate machine (as shown here). In such embodiments, the database 408 may reside behind a load balancer that assigns incoming requests based on resource availability. However, a non-relational data store may be used to store user information and call routing information, provided this information can change in real time in response to call routing requests initiated by the client executing on the user's mobile phone. The application server 404 is the component that, among other things, determines how to route calls between the user (e.g., a traveler) and contact(s) with whom the user wishes to communicate.

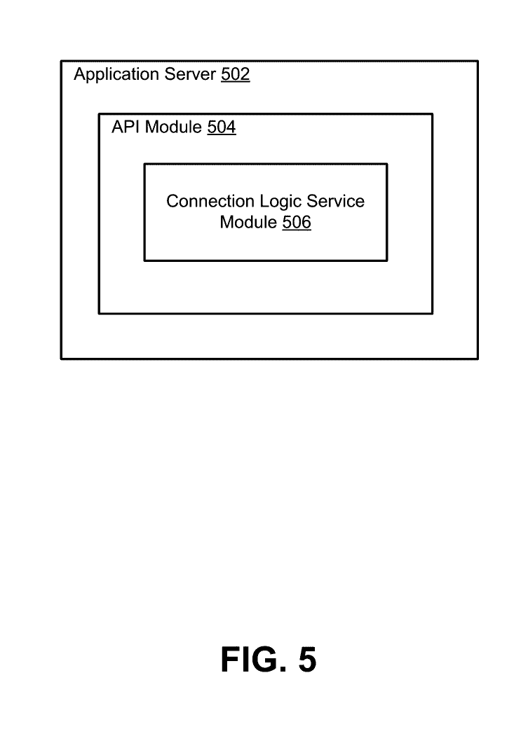

One key component of the application server that enables it to realize the advantages described herein is its use of a connection logic service. As shown in FIG. 5, the connection logic service may be a component of the API module 504 that resides on the application server 502. In some embodiments, the connection logic service is facilitated by a dedicated module (e.g., connection logic service module 506). The connection logic service module 506 may a sub-module of the API module 504 or may be a completely distinct module that is separately executable by the application server 502.

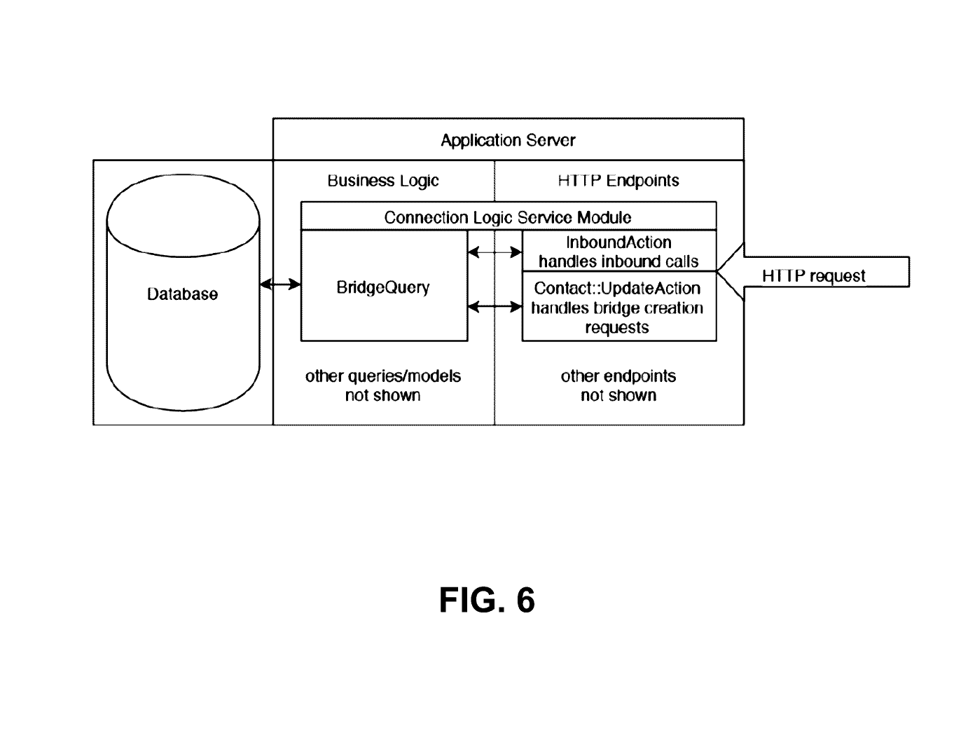

FIG. 6 illustrates how the connection logic service module can handle inbound HTTP requests. More specifically, FIG. 6 depicts an example structure of the connection logic service module, within the larger context of the application server and its interactions with a client and voice services API module.

The application server can exploit a conventional architecture that includes external HTTP interfaces (labeled as HTTP endpoints) and business logic, which includes queries and models that utilize information stored in a database. The information could be used to determine call routing, manage users, and perform other logic-heavy activities, The connection logic service module can include components in one or both of these areas of the application, though in the case of both HTTP endpoints and business logic, the connection logic service module's components are typically not the sole component of these modules.

As shown here, the HTTP endpoints in the connection logic service module can communicate via native APIs with business logic in the connection logic service module. The HTTP endpoints, which may be wrapped in a thin routing layer, may dispatch inbound HTTP calls and return HTTP responses. The HTTP calls and/or the HTTP responses could be encoded using JSON or XML. The business logic can then communicate with a database to store and retrieve data via a protocol specific to that database, such as MySQL.

In one preferred embodiment, the connection logic service module includes multiple HTTP endpoints, InboundAction and Contact::UpdateAction, and one business logic query, BridgeQuery. Other embodiments may structure these endpoints and/or business logic differently, provided that the endpoints respond to bridge creation requests with a newly assigned bridge or an error stating that a bridge could not be assigned. InboundAction may receive an HTTP notification that includes the particulars of an inbound call from a voice services API module, including the phone number called and the phone number of the caller. InboundAction can parse the incoming HTTP request, query BridgeQuery to determine whether a bridge exists that matches the call information, and then either return XML over HTTP representing a “hang up” response to the voice services API module or return XML over HTTP directing the voice services API module to connect the call to a destination number. In some embodiments, the direction to form a connection includes parameters, such as a maximum call length.

Contact::UpdateAction can then receive an HTTP request from a client stating that a user wishes to activate a bridge for a contact or reset the access number to one that is local to the user's current location (potentially in addition to other updates to the user's or contact's information). Contact::UpdateAction can validate the user to ensure they have a local number to bridge from. In some embodiments, additional validations can be performed (e.g., the verification status of the active local number). Contact::UpdateAction then queries BridgeQuery for either a new or updated bridge to connect the user and the selected contact. If bridge creation fails, Contact::UpdateAction can send an HTTP response indicating the nature of the failure. However, if bridge creation succeeds, Contact::UpdateAction can send an HTTP response that includes information on the newly-created bridge (e.g., active local number, access number, callback number, or destination number).

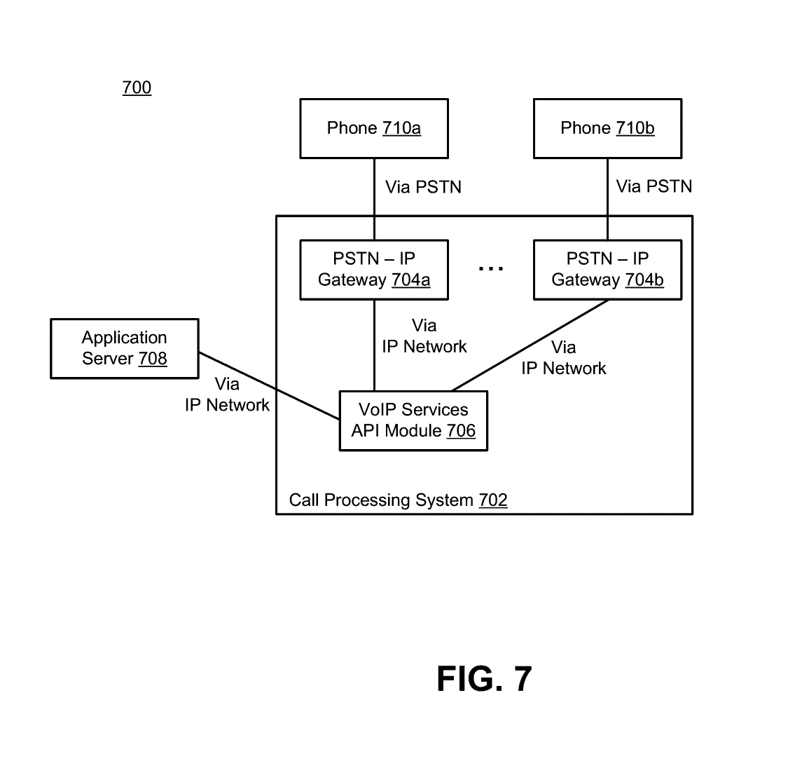

FIG. 7 depicts a generalized illustration of a network environment 700 that includes a call processing system 702 interconnected with other components of an international call system. The call processing system 702 can include multiple conventional PSTN-IP gateways 704a-b, where at least one PSTN-IP gateway is associated with each country in which users and contacts are currently located. The PSTN-IP gateways 704a-b are able to convert signals between a PSTN and an IP network (e.g., using conventional conversion techniques).

The call processing system 702 also includes a VoIP services API module 706 that supports or performs services for facilitating the operation of the international call system. For example, the call processing system 702 may use a VoIP infrastructure-as-a-service system (e.g., Twilio) that makes it possible for inbound calls from mobile phones to notify a defined HTTP Uniform Resource Locator (URL) on an application server 708 with a pre-defined data payload. The application server 708 may then reply over HTTP to determine the call processing system's next course of action. In some embodiments, the call processing system 702 abstracts the PSTN-IP gateways 704a-b and the networks to which the gateways are linked to facilitate the realization of at least some of the advantages described herein. However, partially or fully self-hosted IP-based or time-division multiplexing (TDM) based call routing facilities, whether exposed via an HTTP API or otherwise, may alternatively be used, provided those facilities can communicate with the application server 708 to make routing decisions, and provided those facilities interconnect with the PSTN on both the user phone and contact phone sides.

As shown in FIG. 7, the call processing system 702 is in communication with the application server 708 and multiple mobile phones 710a-b. This can be accomplished by linking the call processing system 702 to both a PSTN and an IP network. The PSTN-IP gateways 704a-b make it possible for the mobile phones 710a-b connected to the PSTN to communicate indirectly with the VoIP services API module 706. More specifically, the PSTN-IP gateways 704a-b can convert PSTN signals received from the mobile phones 710a-b into IP messages that are passed to the VoIP services API module 706. Moreover, the PSTN-IP gateways 704a-b can convert IP messages transmitted by the VoIP services API module 706 into PSTN signals that are passed to the mobile phones 710a-b. Communication between the VoIP services API module 706 and the application server 708, meanwhile, can be enabled by the IP network.

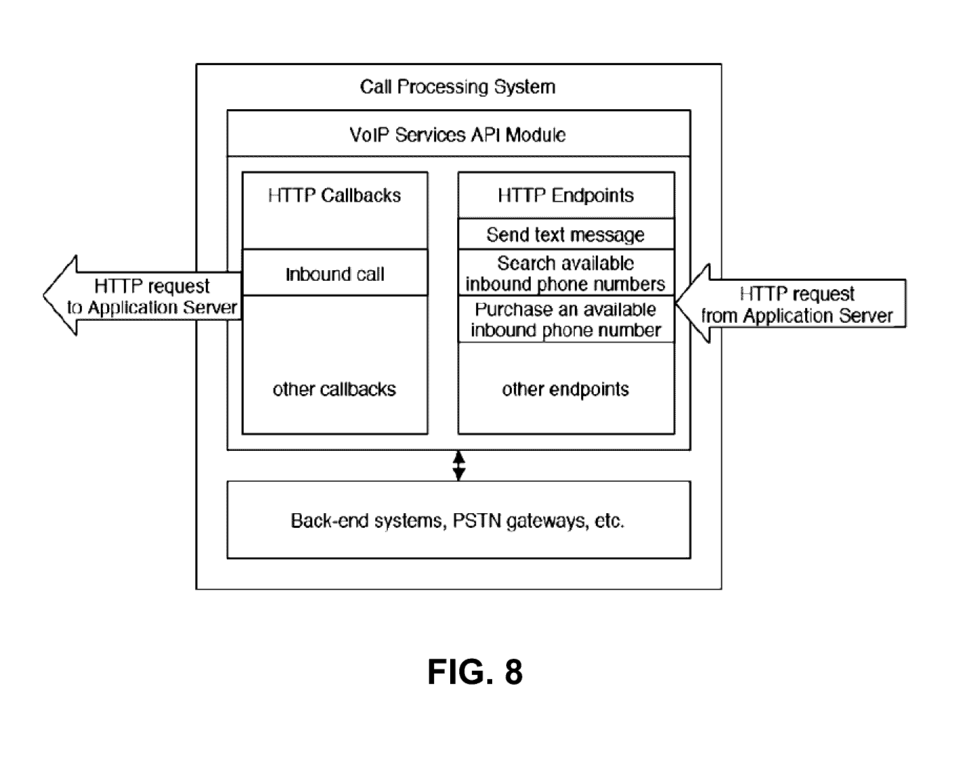

FIG. 8 illustrates how a VoIP services API module can handle inbound HTTP requests from an application server. As shown here, the VoIP services API module can include numerous components. For example, in some embodiments the VoIP services API module exploits conventional architecture and includes HTTP endpoint(s), HTTP callback(s), and back-end system(s), which may be used in support of the HTTP endpoint(s) and the HTTP callback(s). The HTTP endpoint(s) can include, for example, modules for sending text messages, searching for available inbound phone numbers, purchasing available inbound phone numbers, etc. The HTTP callback(s) can include a module for inbound calls and possibly other callbacks. The HTTP endpoint(s) can receive HTTP requests from the application server, while the HTTP callback(s) can transmit HTTP requests to the application server. Both the HTTP endpoint(s) and the HTTP callback(s) may be in communication with one or more back-end systems, PSTN-IP gateways, etc.

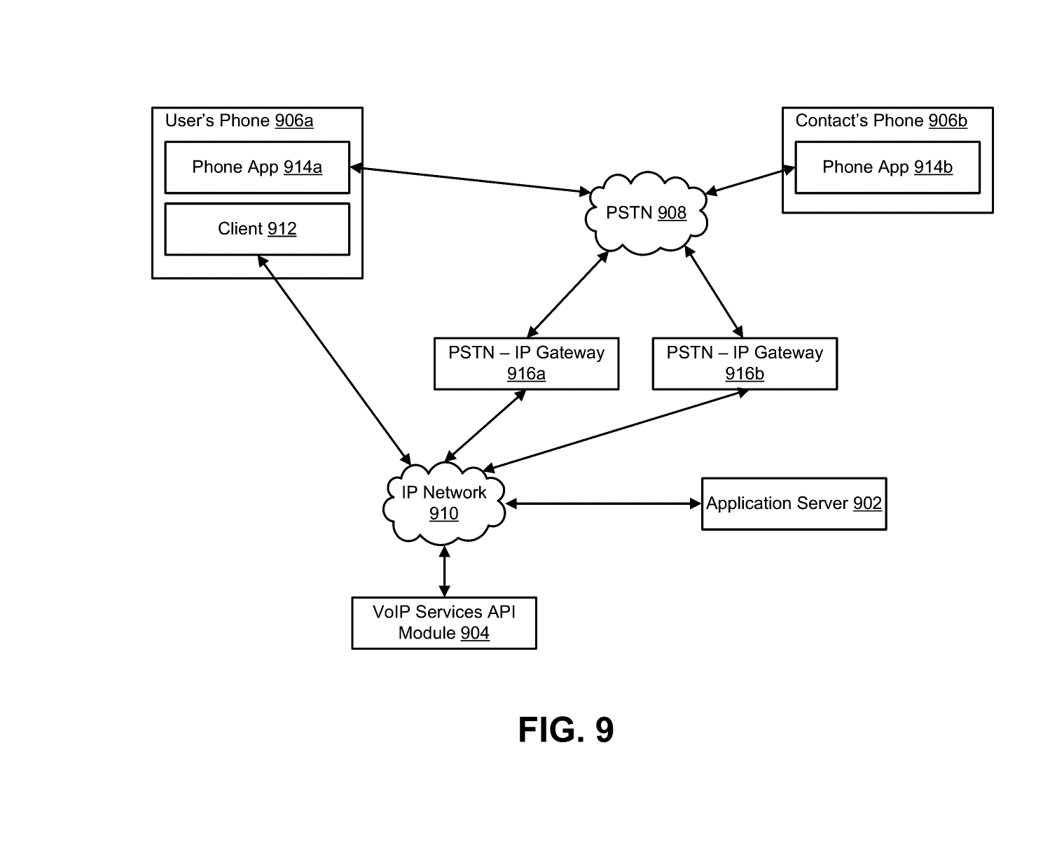

FIG. 9 depicts a generalized illustration of the network interconnections between an application server 902, a VoIP services API module 904, and multiple mobile phones. The mobile phones are operated by users (e.g., a user's mobile phone 906a and a contact's mobile phone 906b) who intend to communicate with one another using an international call system. As noted above, the international call system could exploit both a conventional PSTN 908 and a conventional IP network 910 for communication among the various components.

Phone applications 914a-b (also referred to as “phone apps”) executed by the mobile phones 906a-b can communicate with one another directly via the PSTN 908. As shown by FIG. 9, a client 912 executing on the user's mobile phone 906 may be connected to the IP network 910, which enables the client 912 to communicate with the application server 902 and/or the VoIP services API module 904. One or more PSTN-IP gateways 916a-b can be connected to both the PSTN 908 and the IP network 910 and serve as an interface between the two networks.

### Operations of an International Call System

As noted above, the international call systems described above (and supporting infrastructure) can be used to make low-cost international calls. However, a user (e.g., a traveler) will typically have to initiate such a process using a client executing on a mobile phone.

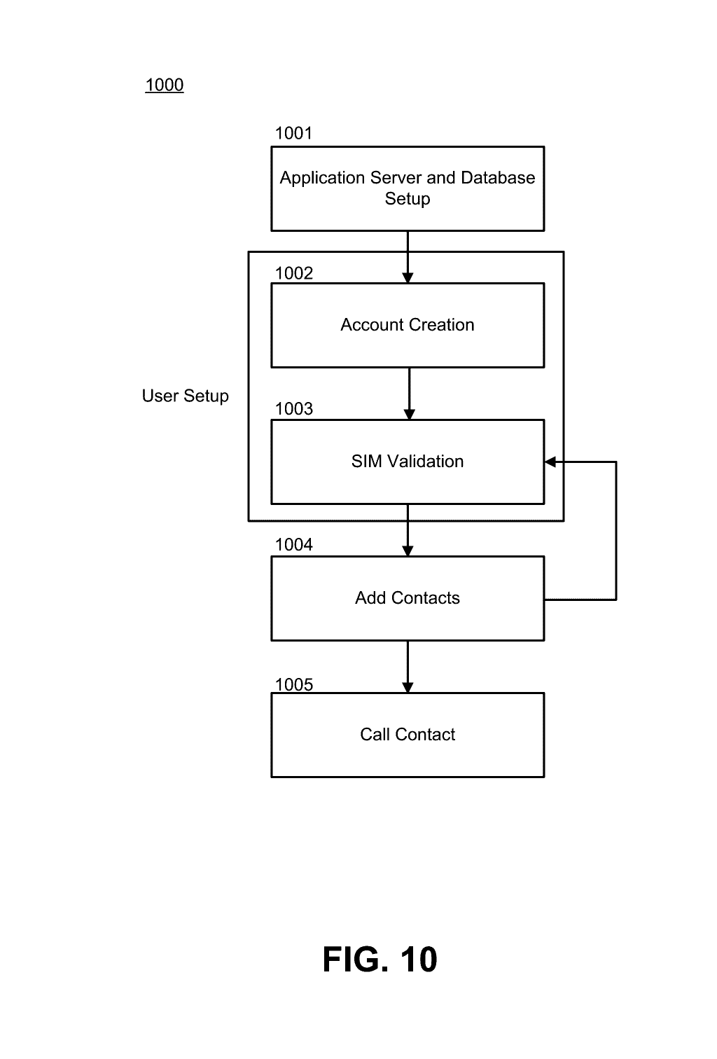

FIG. 10 depicts a flow diagram of a process 1000 for making low-cost international calls. More specifically, FIG. 10 schematically illustrates the sequence of steps utilized for setting up the client and application server so that a traveler can place and/or receive international calls.

As shown here, the application server and database are initially setup (step 1001). This step is preferably carried out prior to all other operational steps in order to expedite the execution of the remaining steps. Unlike the subsequent steps, which can be carried out by the user, this step may be carried out by a system administrator or an automated procedure.

The user can then set up an account with a calling service that manages the international calling system by performing a sequence of two steps. First, the user can create an account with the calling service (step 1002). For example, the user could input information (e.g., personal or financial information) into the client executing on the user's mobile phone. Second, the user can validate the SIM card installed within the mobile phone (step 1003). Note that a new user will typically be required to complete both of these steps, and, upon completion, the user will be able to make low-cost international calls from a single country. However, if the user has already carried out these steps but wants to configure the mobile phone to make low-cost international calls from another country, he can do so by repeating execution of the SIM validation step for the new country.

Once the user has completed the setup process, the user can add contacts to the client (step 1004). For example, the user could specify a phone number or some other identifier (e.g., an email address or name). The user can then place a low-cost international phone call to an individual listed within the contacts list by selecting that individual (step 1005).

As noted above, once a user sets up an account with the calling service and adds contacts, the user will be able to place low-cost international calls from a single country. The single country will be the one that is associated with the phone number, which, in turn, is associated with the conventional SIM card that is in the phone when the user completes the setup process. However, the user will not be able to make low-cost international calls from any other countries. In order to do so, the user must replace the SIM card that was in the mobile phone when it was initially set up with another SIM card corresponding to a phone number associated with a different country.

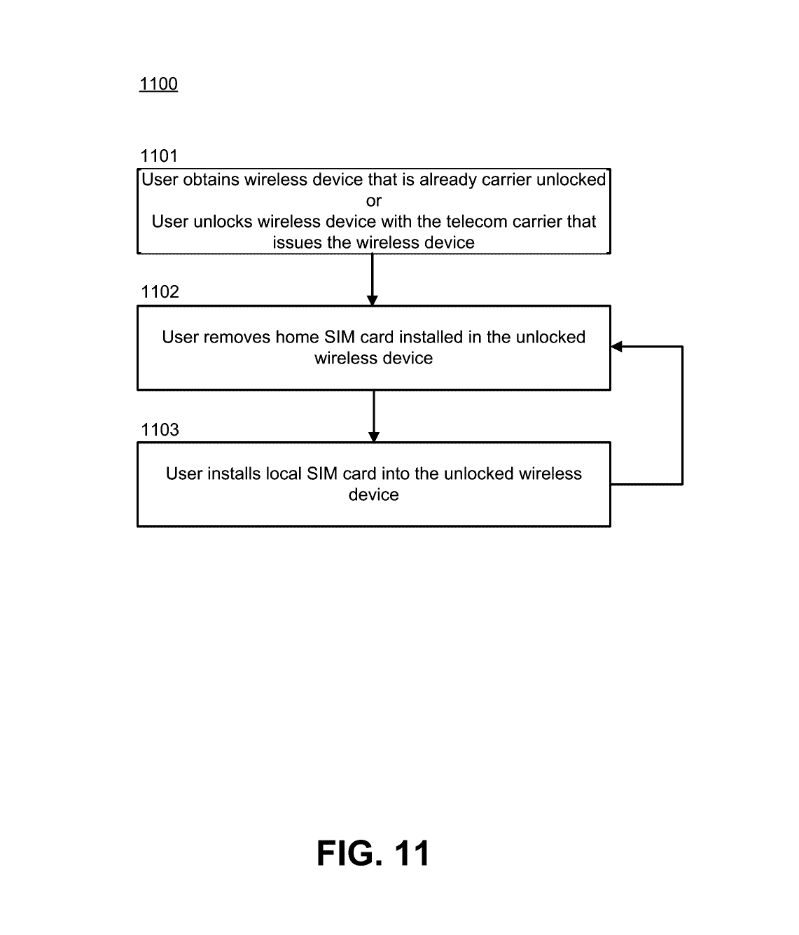

FIG. 11 depicts a flow diagram of a process 1100 for swapping SIM cards, thereby enabling the user (e.g., a traveler) to complete low-cost international calls from multiple countries. The process 1100 may require that the user go through the entire setup process with the calling service (i.e., complete steps 1002-1003 of FIG. 10). Alternatively, completion of step 1003 for SIM validation may be necessary, while completion of step 1002 for account creation may be optional (though some information will be added to the account).

If the mobile phone is locked, the first step for the user is to unlock it. For example, the user can obtain a mobile phone (or some other computing device, such as a tablet or laptop) that is already carrier unlocked, or the user can unlock the mobile phone with the telecom carrier that issued the mobile phone (step 1101). This step can be skipped if the mobile phone is already unlocked. The user can remove the SIM card associated with the first country from the mobile phone (step 1102). A new (conventional) SIM card associated with the second country can then be installed into the mobile phone (step 1103). Afterwards, the user can validate the SIM card (i.e., complete step 1003 of FIG. 10) in order to allow the international call system to use the new phone number corresponding to the newly-installed SIM card.

Note that the user will typically not need to re-complete the account creation process, nor will the user have to re-add the contacts previously entered into the client. Instead, the user will generally be able to continue to make low-cost international calls to those contact(s) that have already been added (though the user may also choose to add new contacts after installing the second SIM card). When the user travels to other countries, the process 1100 can be repeated by replacing the SIM card and repeating the SIM card validation step, which enables the international call system to make low-cost calls from the country associated with the currently-installed SIM card.

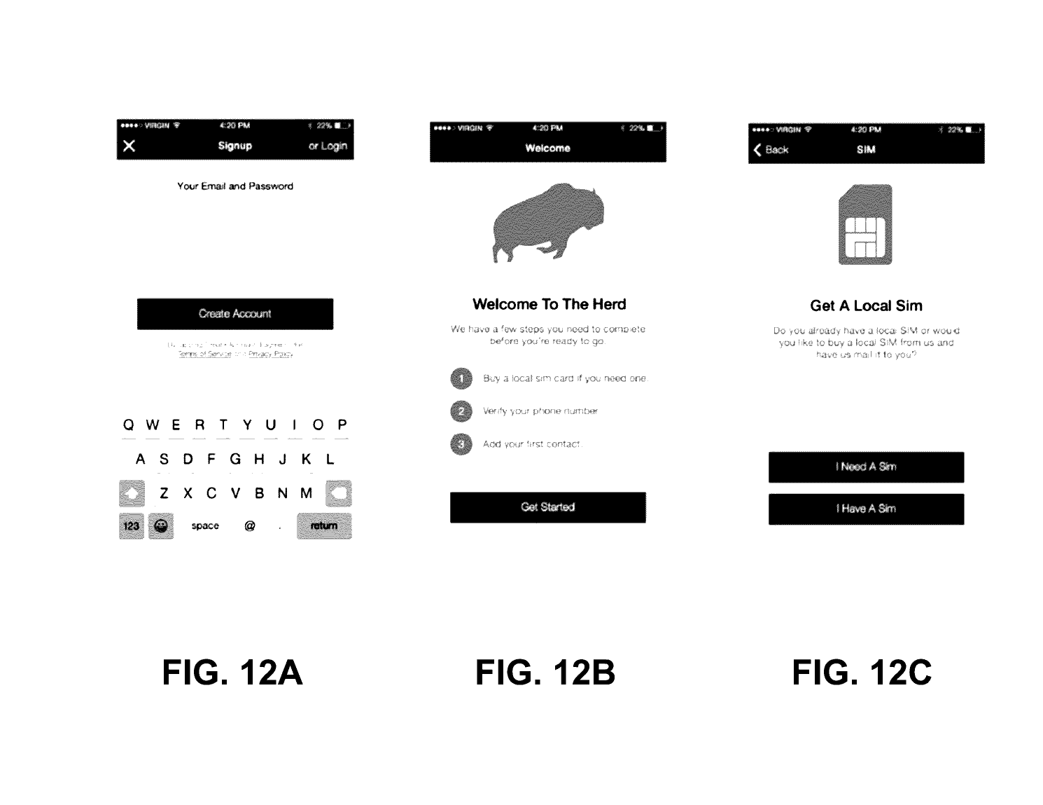

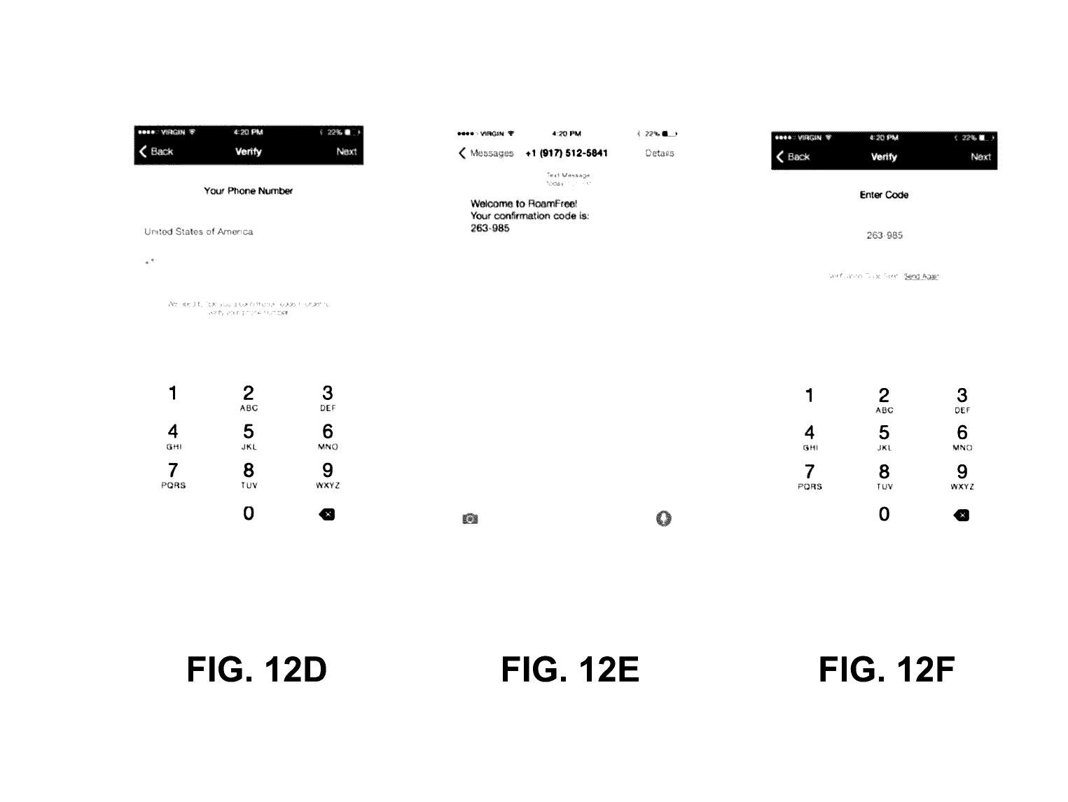

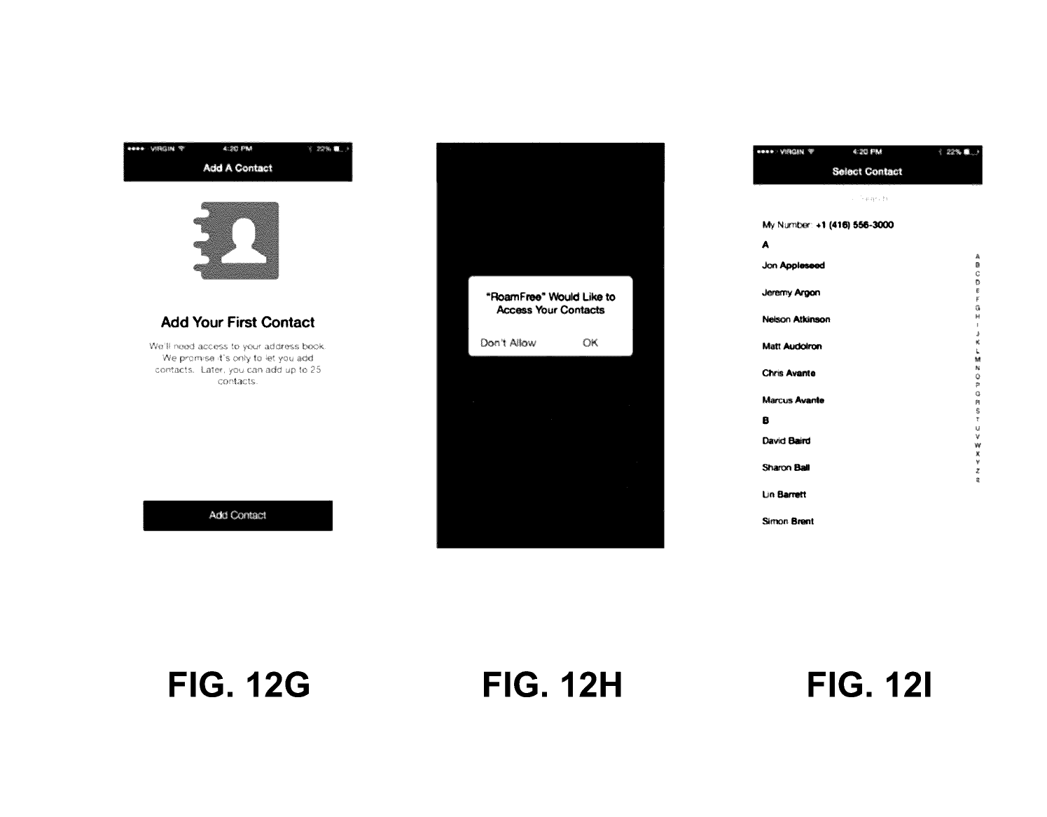

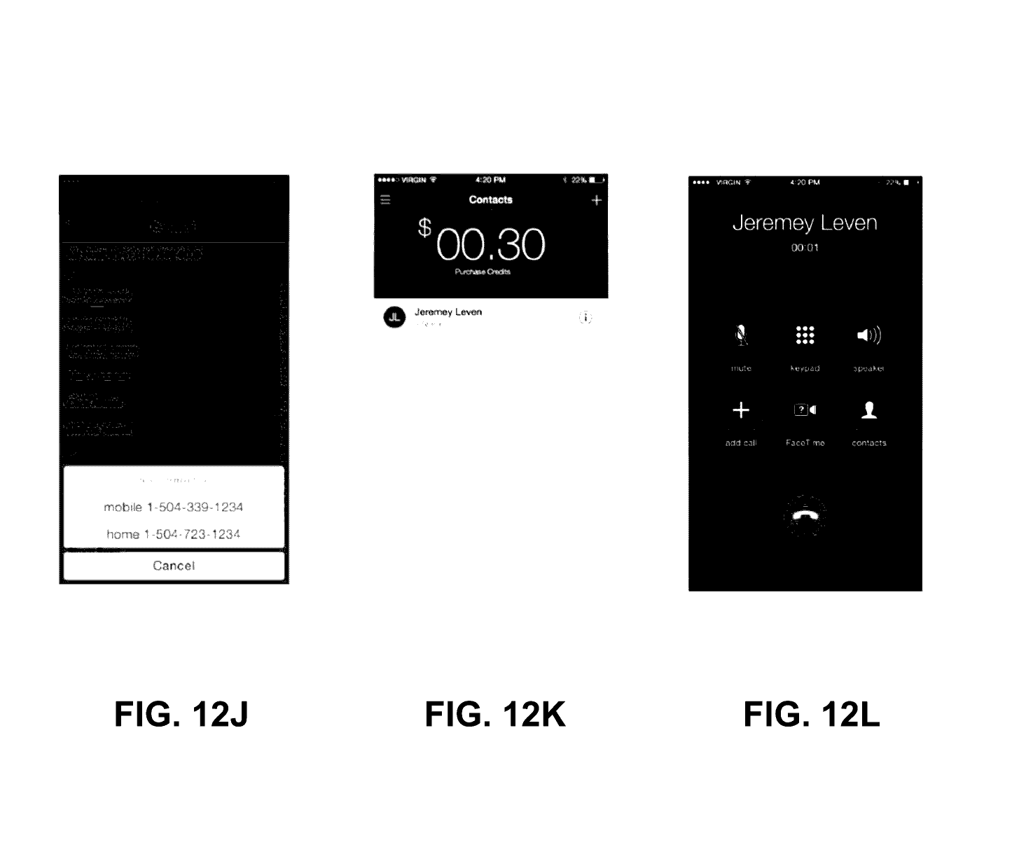

FIGS. 12A-L depict a series of interfaces that illustrate these processes (e.g., processes 1000 and 1100 of FIGS. 10-12, respectively) from a user's perspective. These interfaces can be created and presented by a client, which preferably resides on the user's mobile phone. The client could be implemented as a native application. Here, for example the client is depicted as a native iOS application executing on an Apple iPhone for the purposes of illustration. However, equivalent steps could be carried out on a wide variety of computing devices using a wide variety of client implementations.

FIG. 12A depicts a “sign up” interface that can be used to gather information from the user during the account creation process. For example, the user may enter an email address and password in a standard iOS dialog and then tap the “Create Account” button. In some embodiments, the international call system verifies the email address and/or the password as being recognizable and valid for creating a new account. FIGS. 12B-C illustrate two informational interfaces that could be presented before validating the SIM card. More specifically, FIG. 12B depicts a “Welcome” screen that explains the setup process to the user, while FIG. 12C depicts a “SIM” screen that gives the user the option of purchasing a SIM card if the user doesn't already have one.

The user can then proceed to validate the SIM card, as shown by FIGS. 12D-F. FIG. 12D depicts an interface that prompts the user to enter the phone number associated with the SIM card for verification. After entering the phone number, a verification code could be sent to the phone number. For example, the verification code may be sent via SMS and received by the user as a text message, as shown by FIG. 12E. FIG. 12F depicts an interface illustrating how the client can prompt the user to enter the verification code received via text message. Once the user has entered the verification code and the code has been validated (e.g., by the client and/or the application server), the SIM card will have been successfully validated.

FIGS. 12G-J illustrate how contacts can be added by the user when accessing the international call system for the first time. After successfully validating the SIM card, the user may be instructed to add contacts from the mobile phone's address book or a contacts application, as shown in FIG. 12G. As shown in FIG. 12H, the user may be prompted to allow access to the contacts in the address book after tapping the “Add Contact” button. If the user taps “OK,” a list of contacts stored on the mobile phone can be displayed, as shown in FIG. 12I. Selection of a contact in the list may cause the client to display any phone number(s) for that contact that are stored on the mobile phone, as shown in FIG. 12J.

When the user selects a phone number, the phone number and the name of the corresponding contact can be added to the list of contacts maintained by the international call system. As shown in FIG. 12K, the name of the corresponding contact can be shown by the client and made available for selection by the user. More specifically, the user can make a low-cost international call to the contact by tapping the contact's name in the list. Tapping the list may direct a phone application executing on the mobile phone to place a call to the contact's number, as shown in FIG. 12L.

The process of adding contacts by a user who previously set up an account with the international call system for at least one SIM card is similar, but may not require the user experience the interfaces shown in FIGS. 12A-B and G-H. Said another way, the user may not have to reenter account information, specify contact instructions, or permit access to the contact list of the mobile phone.

Database setup can be carried out when the international call system is initially configured and prior to making the database accessible to potential users (e.g., travelers). One of the purposes of database setup is to obtain a pool of phone numbers local to the countries the international call system supports. For example, a pool of domestic German numbers could be obtained to support Germany, while a pool of domestic French numbers could be obtained to support France. These numbers are referred to as “access numbers” and “callback numbers.” Access numbers are associated with the country in which the user is currently located, while a callback number is linked to the country that is associated with the SIM card installed within the contact's phone. As further described below, access numbers and callback numbers can be used in connection with a bridge data structure.

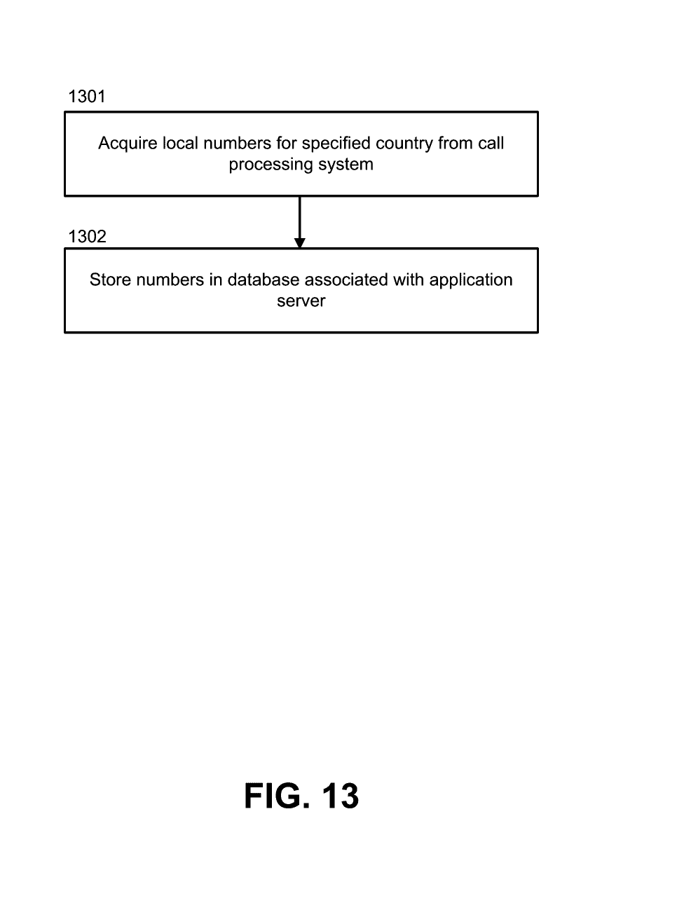

Setting up the database requires completion of at least two steps, as shown in FIG. 13. First, a pool of suitable access numbers and callback numbers is obtained (step 1301). In some embodiments, these numbers are obtained from the call processing system. Second, the pool of suitable access numbers and callback numbers is stored in the database (step 1302), which is communicatively linked to the application server. These steps can be carried out manually by an administrator running specific software scripts or via an automated or semi-automated process.

In some embodiments, the application server locally maintains a whitelist of acceptable countries for users and contacts, as well as a list of access numbers the application server may use as bridge endpoints, which are populated as part of the database setup process. For example, these access numbers may be represented as a list of internationally formatted (e.g., E.164) phone numbers that are grouped by call processing provider. Each number could also have its associated country precomputed as a performance measure, and the list of acceptable countries may be precomputed. Available country and phone number information could be used to validate requested local and contact numbers and to assign new bridges.

In some embodiments, the application server queries the associated call processing system for access numbers in real time (i.e., “on the fly”) rather than storing the list of available access numbers locally, However, such a configuration is typically accompanied by a performance penalty (in comparison to having a local lookup table). Such an implementation may require the access numbers and the callback numbers to be stored explicitly as part of the bridge, rather than maintaining references to those numbers elsewhere in the local data store.

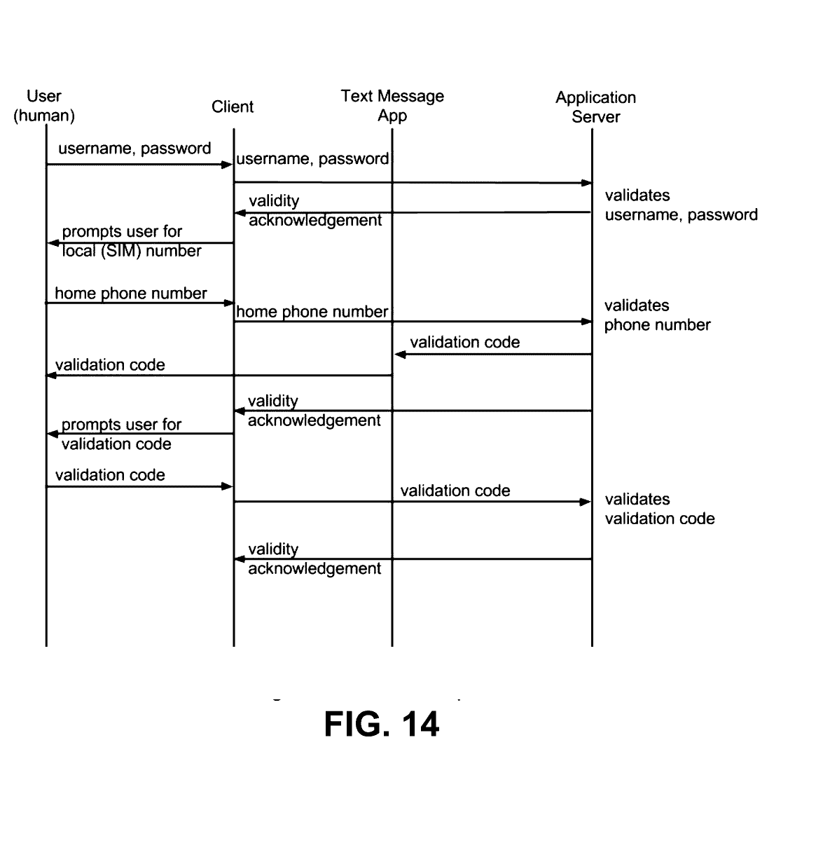

FIG. 14 depicts a flow diagram showing the actions of the user, as well as the associated communication among components of the international call system and the supporting infrastructure. The components of the international call system that play a role in this process can include the client and the applications, and the components of the supporting infrastructure that play a role in this process can include a text messaging application that resides on the user's mobile phone.

The process starts when the user opens the client and provides a username and password (e.g., via the interface depicted in FIG. 12A). The client can transmit the username and the password to the application server for processing. For example, an API module residing on the application server may perform standard validations to ensure that the password is sufficiently long, that is username is not already associated with an account, etc. If the username and password are valid, then the API module can transmit an acknowledgement, via the application server, back to the client indicating the username and password were successfully validated. This acknowledgment may be in the form of an HTTP 200 code, though it will be apparent to one of ordinary skill in the art that there are many possible alternatives.

After completing the account creation process, the client can prompt the user to enter the phone number associated with the SIM card installed within the mobile phone. Upon determining the user has entered the phone number, the client transmits the phone number to the application server. The API module residing on the application server can validate the phone number, for example, by checking its syntax and ensuring the syntax complies with one or more rules.

If the phone number is determined to be valid, the API module can do two things. First, the API module (via the application server) transmits a validation code to the user's mobile phone. For example, this could be accomplished by sending an SMS message to a text messaging application executing on the mobile phone, as illustrated in FIG. 12E. Second, the API module (via the application server) transmits a validity acknowledgement to the client, and the client then prompts the user to enter the validation code that was sent to the mobile phone, as illustrated in FIG. 12F. The user can then enter the validation code into the client, which transmits the validation code to the application server for processing by the API module. If the API module is able to successfully validate the validation code, the API module may transmit a validity acknowledgement back to the client residing on the mobile phone.

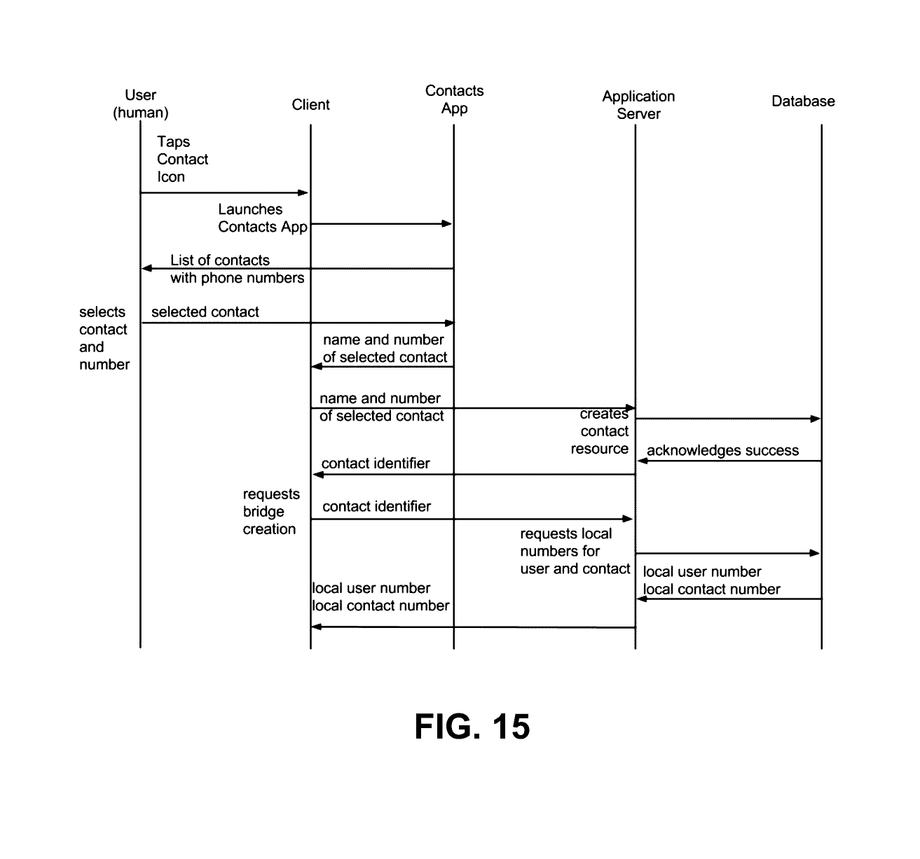

FIG. 15 depicts a flow diagram of a process for adding a contact to the international call system. When the user completes the initial setup process, the user may be prompted to start the process of adding a contact (e.g., via the interface shown in FIG. 12G). Later, however, the user can initiate the process of adding a contact directly by interacting with the user interface of the client. In some embodiments, the client includes an appropriate user interface element, such as the “+” icon in the upper right corner of FIG. 12K, though it will be clear to one of ordinary skill in the art that there are many alternative techniques that can be employed.

Accordingly, the process begins when the user taps an “Add Contact” icon. The client can then access and present the address book stored on the mobile phone. This may take the form of launching the native contacts application, though other variations are possible. The contacts application displays to the user a list of contacts with their phone numbers. As shown here, the user can select a contact and one of the phone number(s) linked to the contact, and the contact application transmits the name of the contact and the selected phone number (as well as possible additional information about the contact) to the client. The client then passes this information to the application server, where the API module can create a resource for the contact and store the resource in a database communicatively coupled to the application server. When the API module receives an acknowledgement from the database that the contact resource has been successfully stored, the API module can transmit a contact identifier associated with the contact resource to the client.

As shown in FIG. 15, the client can then transmit a request to the application server to create a bridge data structure for the contact whose contact identifier is also transmitted to the application server. The API module then requests appropriate phone number(s) for the user to call to reach the contact (i.e., an access number) and for the contact to call to reach the user (i.e., a callback number) from the database and stores these numbers in a bridge data structure. In some embodiments, the bridge data structure also includes additional information retrieved from the database. The API module (via the application server) can transmit these numbers, along with the possible additional information, to the client. These numbers could subsequently be used by the client to place and receives international calls.

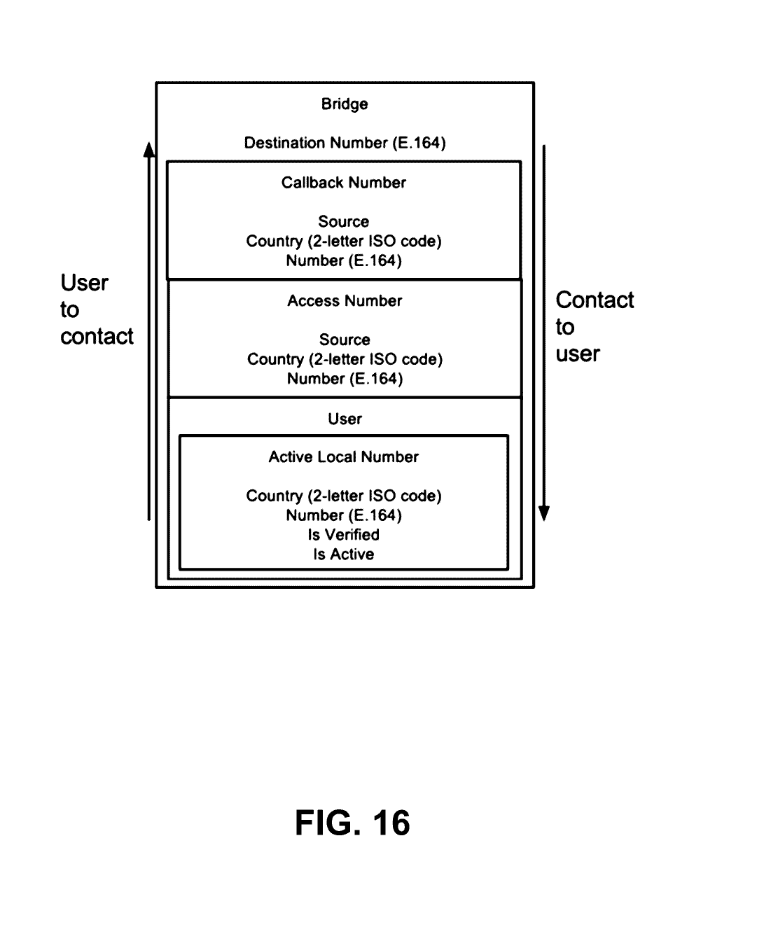

As noted above, when the user adds a contact, a bridge data structure can be created that is used to place a low-cost international call. FIG. 16 depicts an exemplary bridge that includes four phone numbers and associated metadata. The phone numbers are an active local number, an access number, a callback number, and a destination number. The active local number is the number associated with the SIM card currently installed within the user's mobile phone. As shown here, the metadata associated with the active local number can include a code indicating the country associated with the active local number. For example, if the SIM card is intended for making calls within the United States, the country associated with the active local number indicated by the code will be the United States.

The destination number is the number for the contact that is the analog of the active local for the user. That is, the destination number is the number associated with the contact's SIM card and is typically associated with the contact's home country.

The access number is a number associated with the country in which the user is currently located. For example, if the user is traveling in a foreign country, the access number will be a number associated with that country. When the user makes a call to the contact, the access number is the number that is actually dialed. As a result, when the user calls the contact, the user is making a (low-cost) local call rather than an (expensive) long-distance call. Metadata associated with the access number can include a code that identifies the country associated with the access number.

The callback number is a number associated with the same country that the contact's SIM card number is associated with. When the user calls the contact, the callback number is displayed to the contact as a caller identifier (“caller ID”) for the user. Thus, if the contact attempts to call the user back via the caller ID after the user has called the contact, the contact will be making a (low-cost) local call.

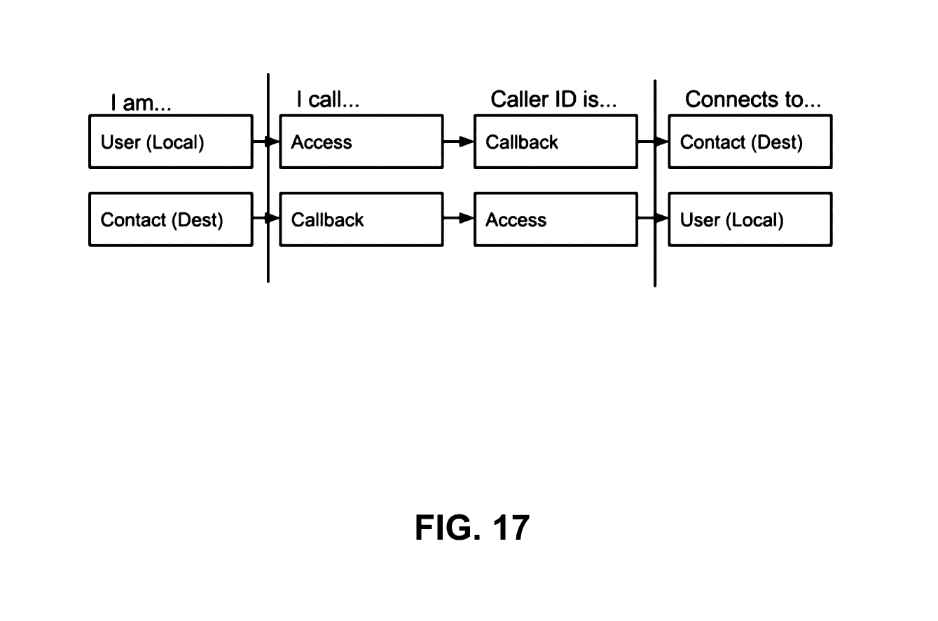

FIG. 17 is a schematic diagram illustrating the roles that the active local number, access number, callback number, and destination number play in routing calls placed between a user and a contact. As shown here, when the user calls the contact, the user initiates the call from the active local number and the call is placed directly to the access number. Another call is then placed to the destination number, while providing the callback number as the caller ID for the user. Conversely, when the contact calls the user, the contact initiates the call from the destination number and the call is placed directly to the callback number. Another call is then placed to the active local number, while providing the access number as the caller ID for the contact.

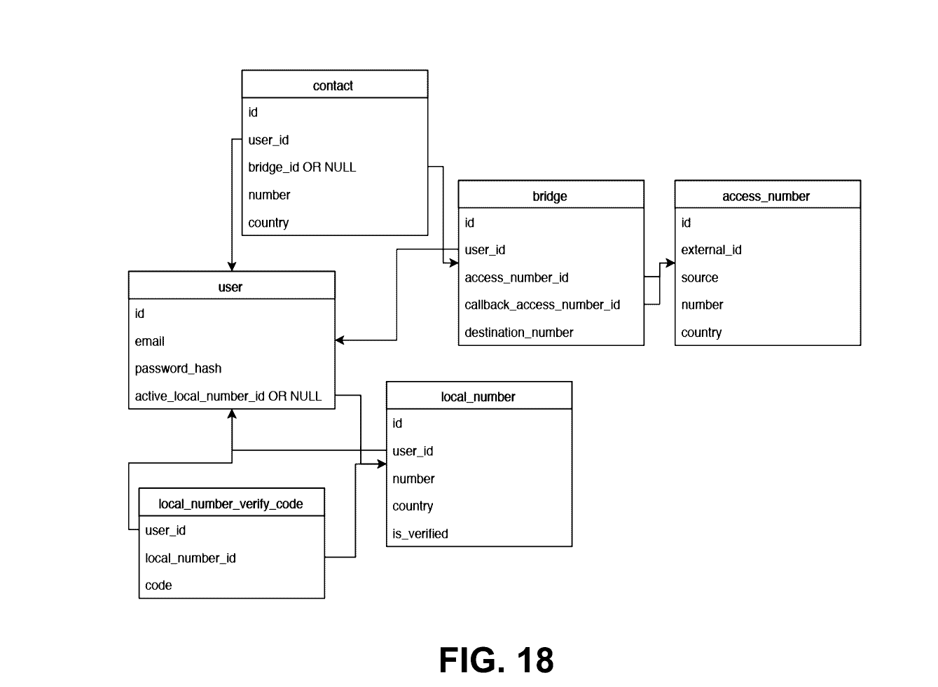

FIG. 18 includes an entity-relationship chart that shows how a bridge data structure could be stored in a relational database. One of ordinary skill in the art will recognize that many other methods could be employed. Note also that objects in the database may have more than the fields shown here in a fully-implemented API module residing on an application server.

The bridge object shown here represents the bridge itself and has a primary key (id), a many-to-one relationship with the user object (via user_id), two many-to-one relationships with the access_number object (via access_number_id and callback_access_number_id), and a destination_number, which can include an E.164-formatted phone number. The access_number object represents a phone number from a voice service provider that the international call system may use as either an access number or a callback number (or as both) for any number of bridges. The access_number object can include a primary key (id), an external_id key (representing the number's identifier in the voice service provider's system), a source identifier (to differentiate between multiple voice providers), a number (in E.164 format), and a country identifier (e.g., a two-letter ISO code for easier bridge calculations). The contact object represents a contact and can include a primary key (id), a many-to-one relationship with a user object (via user_id), a reference to an associated bridge object if one exists (via bridge_id), a number (in E.164 format), and a country identifier (e.g., a two-letter ISO code for easier bridge calculations).

The user object represents a user of the international call system and can include a primary key (id), the user's email, a cryptographic hash of the user's password (password_hash), and a reference to the user's currently active local_number object if one exists (active_local_number_id). The local_number object represents a phone number associated with the user, which may be actively in use, active within the application, verified via text message, or a mix of multiple or none of the three. The local_number object can include a primary key (id), a many-to-one relationship with a user object (via user_id), a number (in E.164 format), a country identifier (e.g., a two-letter ISO code for easier bridge calculations), and a flag noting whether the number has been verified. The local_number_verify_code object represents a verification code sent to a user's local number by text message to verify ownership of the local number and can include a reference to the user object (via user_id), a reference to the local number object (via local_number_id), and the verification code itself.

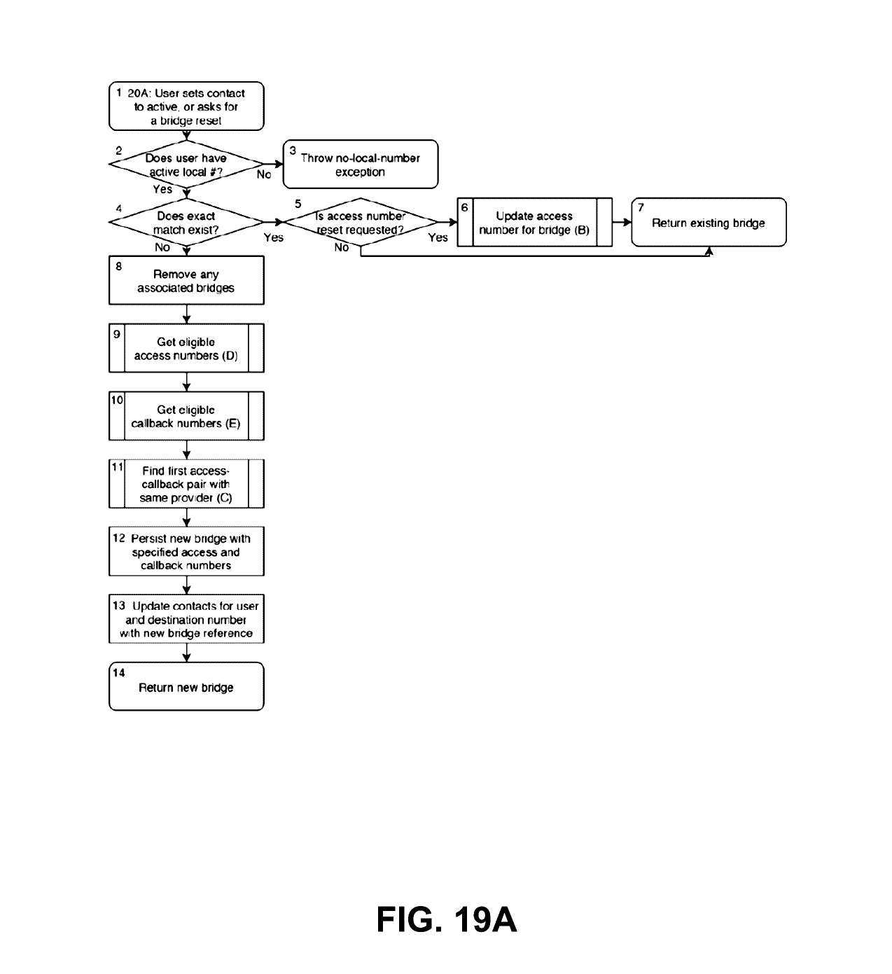

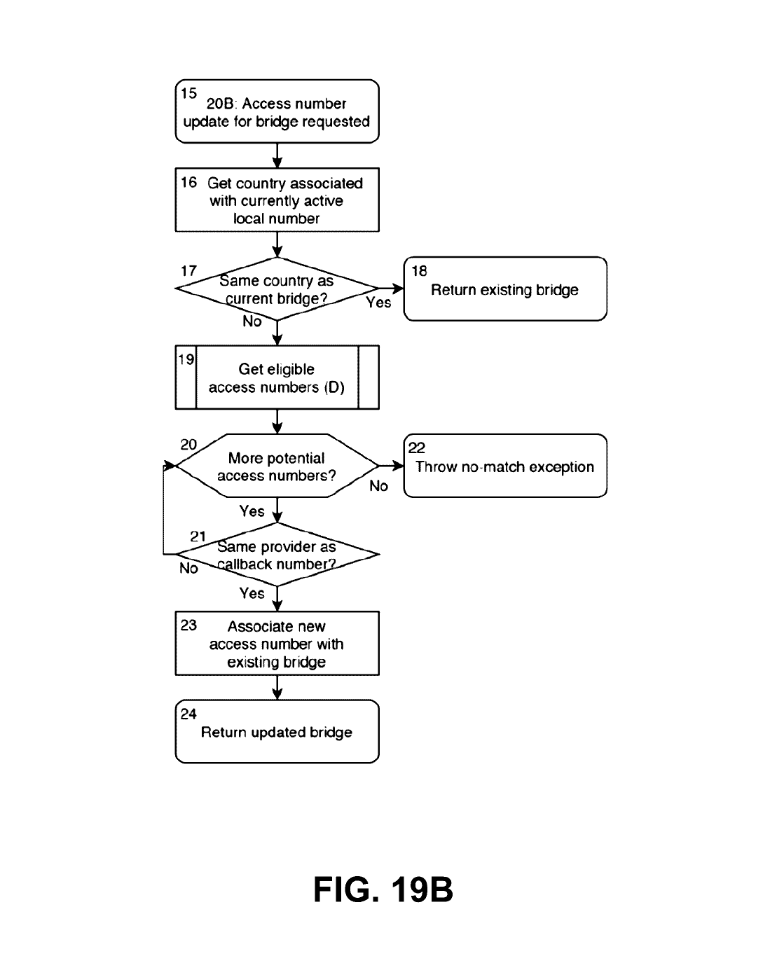

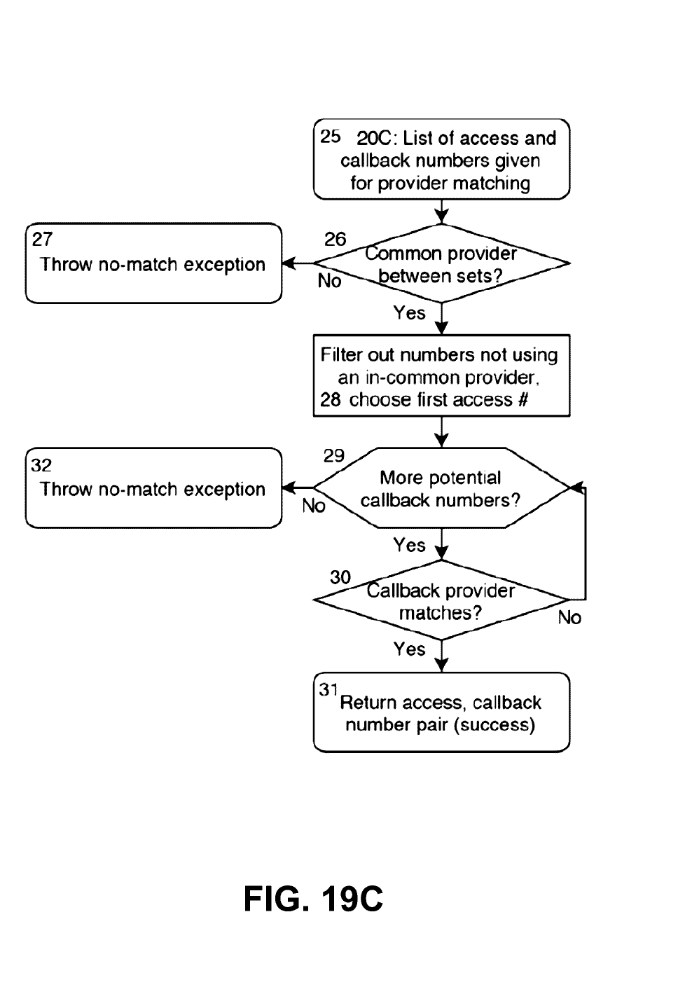

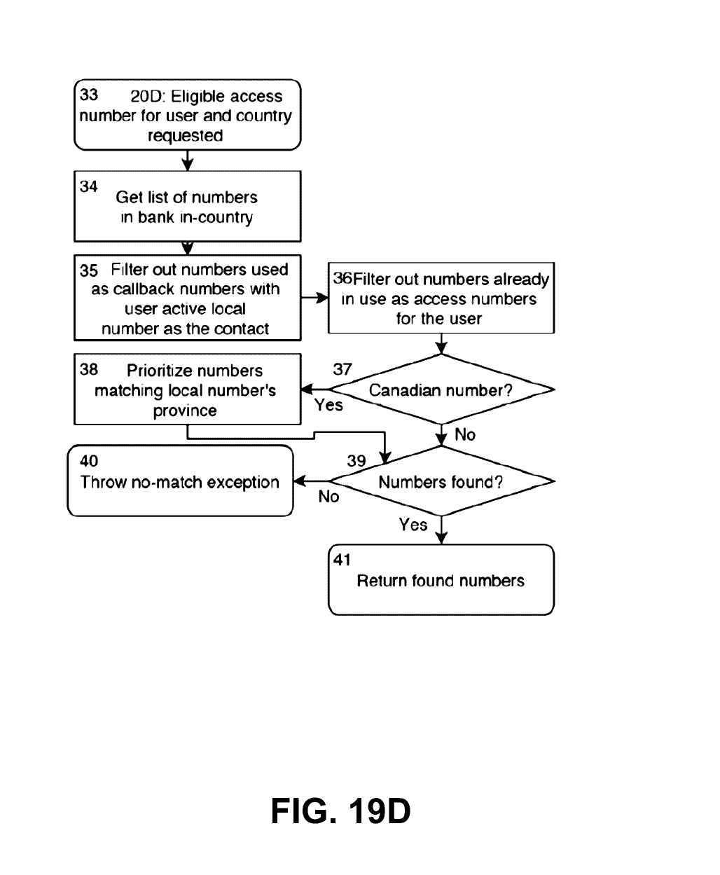

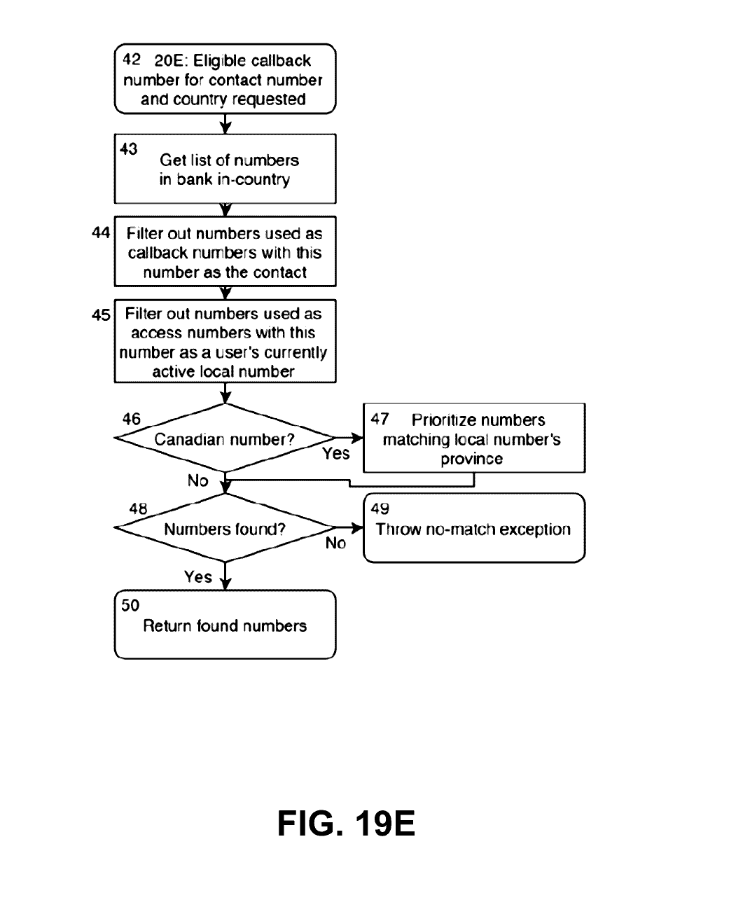

FIGS. 19A-E depict a flow diagram of a process for creating a bridge for a new contact. These figures assume that a user has already added a contact to a client and begin with the user sending a request to set the contact as active (step 1). The request represents an indication of the user's desire to set up a bridge with the contact. FIG. 19A concludes with either a successfully created or updated bridge, or an error condition indicating that a bridge could not be created between the user and the contact. The steps described below could be performed, for example, by a connection logic service module (e.g., connection logic service module 506 of FIG. 5). FIGS. 19A-E also include the scenario in which the user has requested a bridge reset, which attempts to set the bridge's access number to a number local to the user (e.g., if the user has switched countries and is using a new local SIM card).

The international call system (and, more specifically, the connection logic service module) first checks to see whether the user has provided a phone number associated with the currently-active SIM card installed within the user's mobile phone (step 2). If there is none, an error is triggered (step 3). In some embodiments, verification of the phone number by successfully entering a code sent in a text message to that number is a precondition for a local phone number being marked as active.

If the user has an active local number, the international call system then compares the bridge endpoints (i.e., the user's local number and the contact's destination number) to determine whether a bridge connects those endpoints (step 4). If an exact match already exists, the international call system can check to see whether the user requested that the bridge be reset (step 5). In such a scenario, the international call system attempts to update the access number for the existing bridge (step 6, and further shown in FIG. 19B), and then returns the modified bridge if successful. Otherwise, the international call system returns the existing bridge unmodified (step 7).

However, if an exact match is not found, the international call system can remove any bridges associated with the contact (step 8). The international call system then attempts to find access numbers suitable for the bridge (step 9, and further shown in FIG. 19D). If one or more acceptable access numbers are found, the international call system attempts to find one or more callback numbers acceptable for the bridge (step 10, and further shown in FIG. 19E). The international call system attempts to find an access number and callback number that share an intermediate voice service provider (e.g., both numbers are leased from Twilio) if the callback number(s) are found (step 11, and further shown in FIG. 19C).

When the international call system finds available access numbers and callback numbers, the international call system can persist the new bridge to the database (step 12), update contact(s) with the same destination number to use the new bridge (step 13), including the contact for which the bridge request was requested, and return the newly-created bridge (step 14).

FIG. 19B details a procedure for updating an access number to match a user's local country when a bridge reset is requested. The procedure begins when the request is made (step 15). The international call system first retrieves the country of the user's currently active local number (step 16), which is associated with the SIM card currently installed within the user's mobile phone. The international call system can then compare that country to the country corresponding to the access number currently associated with the bridge (step 17). If the access number is in the name country, the existing bridge is returned unmodified (step 18).

However, if the bridge access number and the user's active local number do not belong to the same country, the international call system attempts to find one or more access numbers suitable for the bridge (step 19, and further shown in FIG. 19D). If one or more acceptable access numbers are found, the international call system loops through the list of numbers (step 20) to determine whether any of the number(s) use the same intermediate voice service provider as the current callback number (step 21). If no numbers use the same provider, an exception is thrown (step 22) and the bridge is not modified. If a potential access number does share the same provider, the access number is associated with the existing bridge (step 23) and the bridge is returned to the user (step 24).

FIG. 19C details the provider matching procedure, beginning with a list of potential access numbers and a list of potential callback numbers (step 25), each of which is associated with an intermediate voice service provider. First, the international call system can iterate through both lists to determine a list of providers common to both lists (step 26). If no common providers are found, the international call system exits the process and throws an exception (step 27). However, if one or more common providers are found, both lists can be filtered to remove those providers not found in both lists (step 28). The filtered lists can then be iterated through (step 29) to determine whether the first access number in the list matches the current callback number (step 30). The first callback number to match the first access number is returned along with the first access number (step 31). As a safety valve, an exception could be thrown if all callback numbers have been iterated through and no common provider is found (step 32).

FIG. 19D details a procedure for eligible access number selection (i.e., user to contact call direction). A request is initially received by the international call system for an access number eligible for a given user and a country (step 33). The international call system can retrieve some or all of the numbers available for the country from a bank (step 34). Then international call system then filters out all numbers that are used as callback numbers where the user's current local number is listed as the contact's destination number (step 35). Next, the international call system can filter out those number(s) that are already in use as access numbers for the user (step 36). These steps can be collectively summarized as removing, from the pool of potential access numbers, any phone number(s) that the user can call and be bridged to another user or contact.

In some embodiments, a mapping representing local groups of area codes (usually within a province) is consulted (step 37), and the phone number(s) local to the user's SIM card are prioritized above other potential access numbers (step 38). Such a technique could be effected if the country is, for example, Canada. In either case, if the filtered list of numbers has a nonzero length (step 39), the filtered list is returned to the user (also referred to as “the caller”) (step 41). If no numbers remain post-filtering, an exception could be thrown (step 40) and the bridge is not created. Note that other country-specific prioritizations or filters may be added to further optimize access number assignment.

FIG. 19E details a procedure for eligible callback number selection (i.e., contact to user call direction). The procedure begins with a request for an eligible callback number, given a destination number and the country associated with that number (step 42). First, the international call system retrieves one or more numbers available for the current country from a bank (step 43). Next, the international call system filters out all of the number(s) that are used as callback numbers for bridges where the current destination number is a contact (step 44). The international call system can then filter out any numbers that are used as access numbers for calls from the destination number to contacts within the international call system (e.g., in the case where the contact is also a user) (step 45). These steps can be collectively summarized as removing, from the pool of potential callback numbers, any phone numbers that the contact can call and be bridged to another user or contact.

In some embodiments, a mapping representing local groups of area codes (usually within a province) is consulted and the phone number(s) local to the contact destination number are prioritized above other potential callback numbers (step 47). Such a technique could be effected if the country is, for example, Canada. In either case, if the filtered list of numbers has a nonzero length (step 48), the filtered list is returned to the user (also referred to as “the caller”) (step 50). If no numbers remain post-filtering, an exception could be thrown (step 49) and the bridge is not created.

It will be apparent to one of ordinary skill in the art that other country-specific or region-specific prioritizations or filters may be added to further optimize callback number assignment, and that the prioritization described for provinces and Canada is one of many possible that could be employed for other countries or regions.

As noted above, one of the central capabilities of the international call system is enabling users traveling in foreign countries to make calls to contacts in other countries (and, in some embodiments, allowing those contacts to return calls to the users) without incurring the high costs typically associated with international calls. The process for making such calls is described below. It will be apparent to one of ordinary skill in the art that the same or similar processes can be used in a variety of other situations as well.

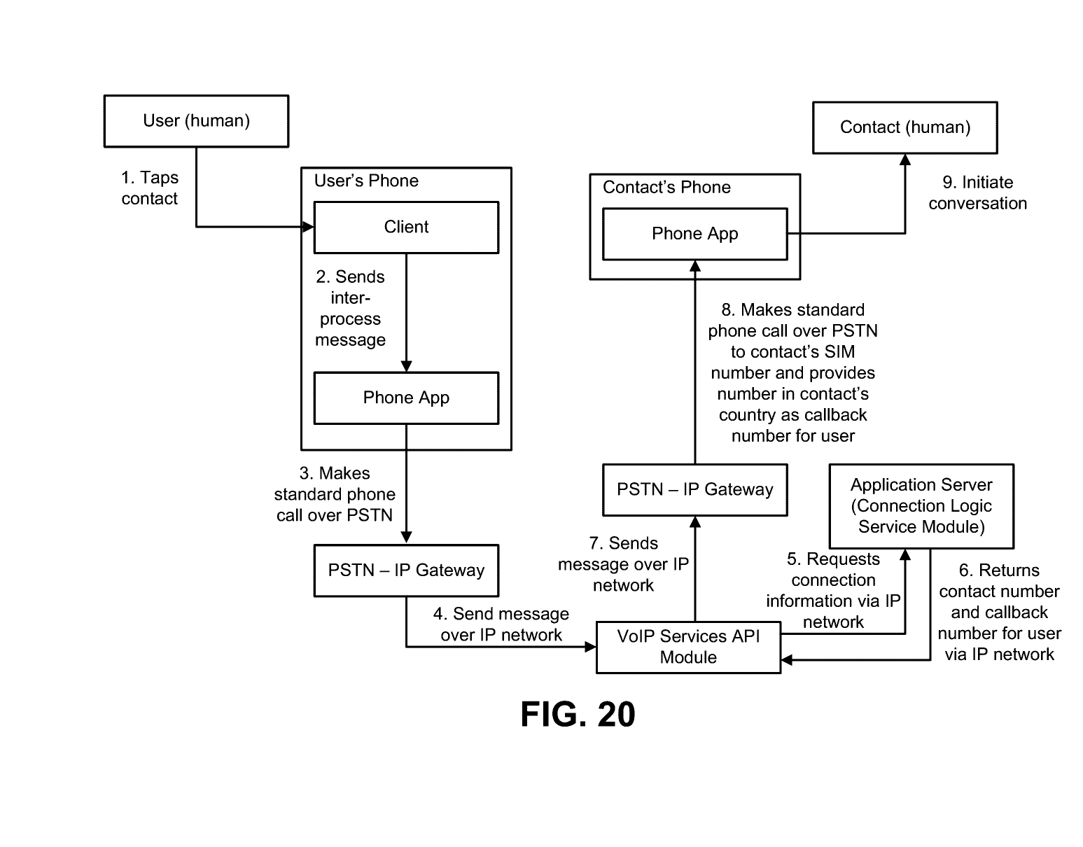

FIG. 20 depicts a process for exploiting the international call system described herein to place a low-cost call from a user in one country to a contact in another country. The user can initiate a call to a desired contact by tapping the contact as displayed in a client residing on the user's mobile phone (step 1). The client responds by sending an inter-process message to a phone application that resides on the same mobile phone as the client (step 2). In response, the phone application can make a standard phone call over a PSTN to the access number previously provided when the user added the contact (step 3). The call to the access number is routed to a PSTN-IP gateway, and then converted into an IP message, which can be sent to a VoIP Services API module (step 4).

The VoIP services API module can then send a request to the application server (and, more specifically, to a connection logic service module) to obtain data needed to complete the call (step 5). In response, the application server returns data that may include the destination number for the contact and a callback number for the user (step 6). The VoIP services API module next transmits a message over the IP network to a PSTN-IP gateway to place a call to the destination number (step 7). In some embodiments, the message is accompanied by a request to display the callback number to the contact as a caller ID for the user. The PST-IP gateway makes the call to the contact's phone, which could be handled by a native phone application residing on the contact's mobile phone (step 8). Responsive to receiving the call via, for example, the native phone application, the contact can speak with the user (step 9).

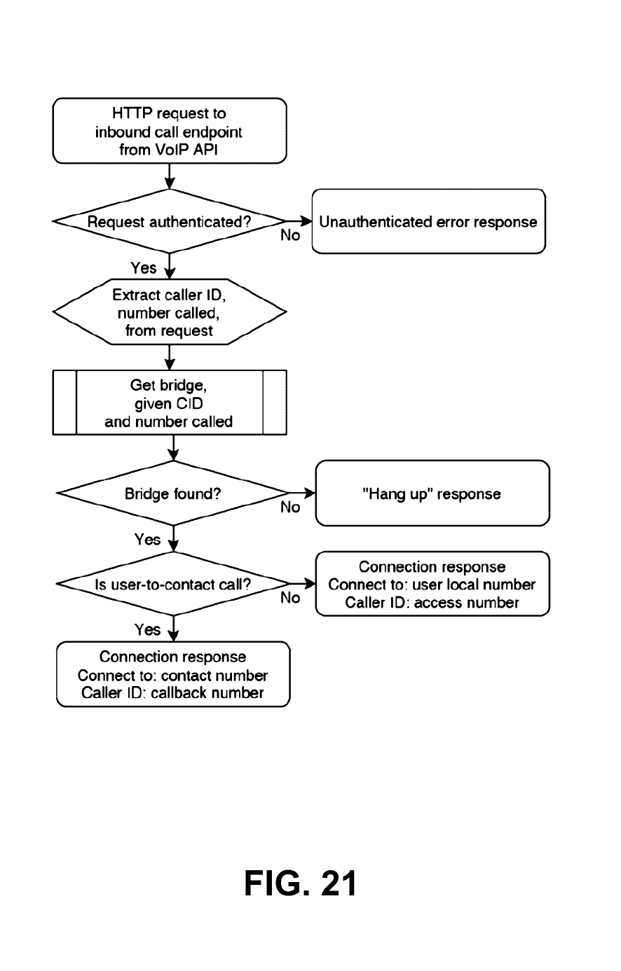

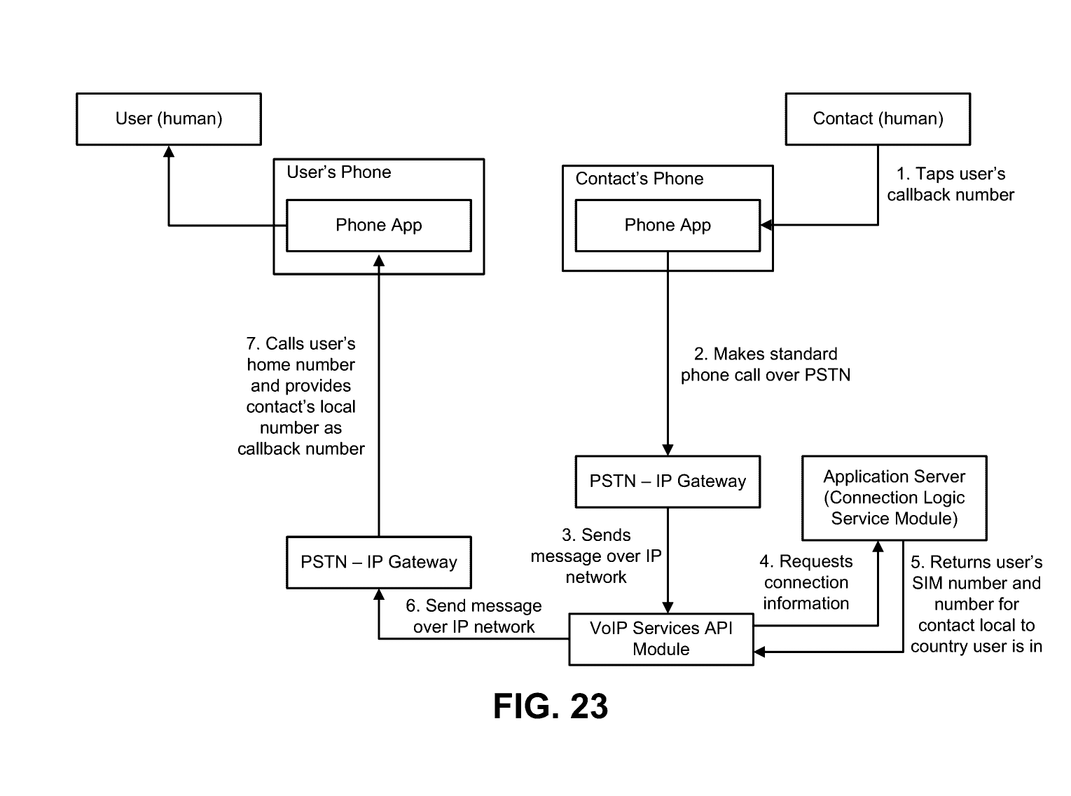

FIG. 21 depicts the life cycle of an HTTP request initiated by the VoIP services API module and received by the connection logic service module's InboundAction endpoint within the API module residing on the application server. The life cycle begins with the request arriving at the connection logic service component of the API module residing on the application server (which is also shown as step 5 of FIG. 20 and step 4 of FIG. 23). The request is first checked for proper authentication credentials. If the credentials do not match those expected by the application server, the process ends by returning an HTTP error indicating that the client is unauthorized.

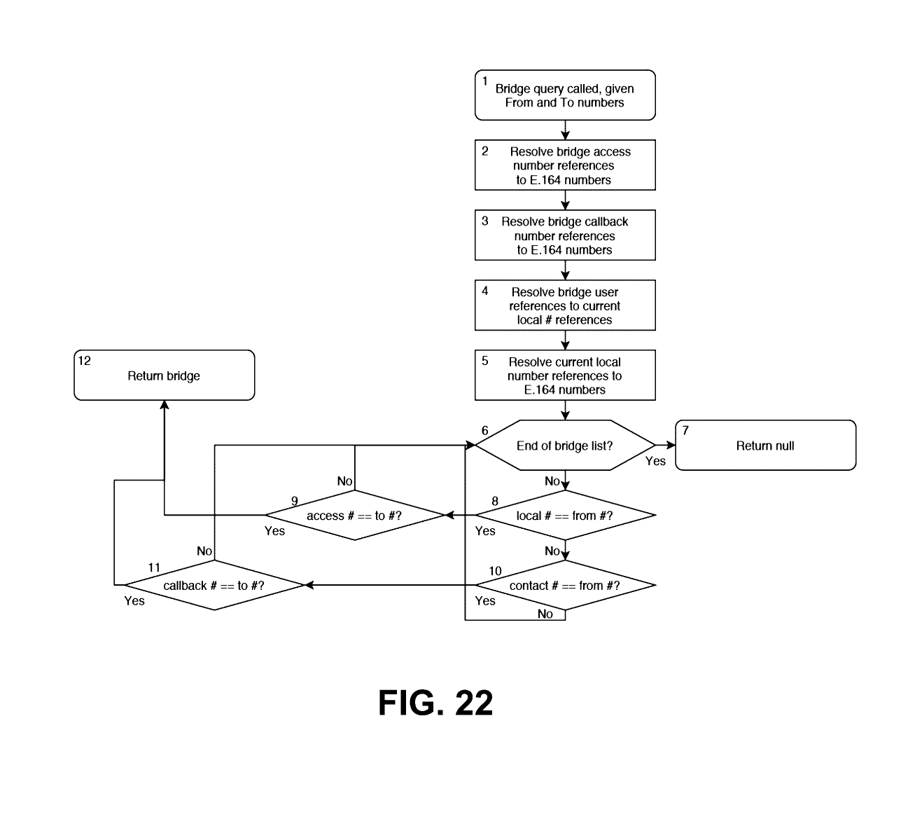

But if the request is successfully authenticated, the number called (which is typically owned by the voice service provider) and the number making the call (which is owned by the user or contact) are parsed from the request body, and then passed as parameters to a query that returns a bridge. The query operations, which take the aforementioned numbers as parameters, are further detailed below with respect to FIG. 22. If no bridge is found, an HTTP response indicating that the voice provider should hang up on the caller is sent back to the VoIP services IP module and the process ends.

However, if a bridge is found, the numbers represented by the bridge can be compared with the caller's number and the called number parsed from the request body. If the call is determined to be a user-to-contact call (e.g., the called number is the bridge's access number), then the international call system can return an HTTP response indicating that the call should be connected with the contact's destination number, while displaying the bridge's callback number on caller ID. Otherwise, the call is determined to be from a contact to a user, and the international call system returns an HTTP response indicating that the call should be connected with the user's currently active local number, while displaying the bridge's access number on caller ID.

FIG. 22 depicts a bridge retrieval process by which a “From” number and a “To” number are resolved into a bridge, along with associated information on how to route the other leg of the call. Note that in the case of a call from a user to a contact, “From” is the user's local number and “To” is the access number, while in the case of a call from the contact to the user, “From” is the destination number and “to” is the callback number. The process commences with receiving an initial query request that includes From and To numbers (step 1). Each of these numbers is typically in E.164 format. One skilled in the art will recognize that the steps shown in FIG. 22 are “flattened” versions of the database query that are preferably used to resolve either the presence of a bridge or the lack of one.

The bridge retrieval process could be partially or entirely carried out by the connection logic service module as part of the processing it performs in response to a request from the VoIP services API module when the user calls the contact or the contact calls the user. The international call system (and, more specifically, the connection logic service module) initially resolves access number references associated with existing bridges to concrete E.164-notated phone numbers (step 2). Next, the international call system similarly resolves callback numbers (step 3). User references on each bridge could be resolved to the resources representing that user's currently active local SIM card (step 4), which may be in turn resolved to the E.164-notated phone numbers associated with those SIM cards (e.g., +12125551212) (step 5). At this point, each potential bridge can include four E.164-notated phone numbers representing the call path for that bridge, and matching the incoming call data to the appropriate bridge can be attempted.

Next, the international call system iterates through the plurality of existing bridges (step 6), continuing until the international call system either finds a matching bridge or runs out of potential matches, in which case the query returns null (step 7). For each potential bridge, a match includes either a user's local SIM number matching the inbound caller ID (step 8) and the called number matching the bridge's access number (step 9), or the contact's destination number matching the inbound caller ID (step 10) and the called number matching the bridge's callback number (step 11). If a matching bridge is found using these criteria, the matching bridge is immediately returned and the query terminates (step 12).

One advantageous feature enabled by some embodiments described herein is the ability to make low-cost international calls from users to contacts and from contacts back to users. Although the client may be required for users to initially call contacts, the client may not be necessary for contacts to call back users. Further, once a user has set up a bridge by adding a contact using the client, the user may be able to subsequently call the contact without using the client.

FIG. 23 depicts a process in which a contact returns a call to a user. The process begins when the contact taps the user's callback number (step 1), which was provided to the contact via caller ID when the user previously placed a call to the contact. In response, a native phone application residing on the mobile phone can make a standard phone call, via a PSTN, to the callback number that is routed to a PSTN-IP gateway (step 2). The PSTN-IP gateway can convert the signal transmitted over the PSTN to a IP message, and then transmit the IP message to the VoIP services API module over an IP network (step 3). The VoIP services API module can send a request to a connection logic service module that includes data needed to complete the call (step 4). As noted above, the connection logic service module may be part of the API module that resides on the application server. The connection logic service module can respond by returning data that includes the active local number and the access number (step 5). Note that the active local number and the access number will be the same active local number and access number used when the user originally placed the call to the contact.

After the VoIP services API module has received the data, it transmits a message over the network to the PSTN-IP gateway to place a call to the active local number and display the access number to the user as the caller ID for the contact (step 6). The PSTN-IP gateway then makes the call to the user's mobile phone, which is handled by the phone application residing on the user's mobile phone (step 7). Responsive to receiving the call via the phone application, the user can initiate the call and speak with the contact (step 8).

Note that the process by which the user makes a call to the contact and the process by which the contact makes a call to the user are very similar. Among the differences are that (1) no client is needed for a contact to call back the user, and (2) the call from the user involves calling the destination number and displaying the callback number as the caller ID, while the call from the contact involves calling the active local number and displaying the access number as the caller ID.

### Usage Scenarios

Numerous exemplary scenarios are described below that further illustrate various principles and benefits of the embodiments described herein. It will be apparent to one of ordinary skill in the art that although specific details of the operation of the international call system are presented, the principles of the international call system provide for a large number of alternative uses.

A. Primary Use Case

A traveler knowing they're traveling abroad obtains a carrier-unlocked mobile phone and acquires a SIM card local to a destination country. After arriving at the destination country, the traveler puts the local SIM card into the carrier-unlocked mobile phone. The traveler then validates the local SIM card with the international call system by interfacing with the client (e.g., a mobile application) that resides on the mobile phone.

More specifically, the traveler can validate the local SIM card by entering the phone number assigned to the local SIM card into the client. The traveler will then receive a PIN code delivered via text message to the phone number the traveler entered as belonging to the local SIM card. The traveler can then enter the PIN code into the client when prompted in order to complete the validation process.

The traveler then adds one or more contacts using the client supported by the international call system by tapping a button labeled “+” in the top right of the screen, selecting one of the contacts via a contact selection tool (e.g., contacts may be populated using the native contacts application residing on the mobile phone), and then selecting a specific phone number to use for that contact.

The traveler can dial the contact by tapping the name of the contact on the home screen of the client. The traveler may repeat the process to add as many contacts as desired and call those contacts at any point in time. Moreover, contacts may be able to call the traveler back at any time using the number they received a call from the traveler on.

Upon returning home, the traveler may wish to stay in touch with a foreign friend made during his travels. The traveler could validate the SIM card from the home country, add the foreign contact through the client, and be able to dial or be dialed at local rates for both parties.

B. Secondary Use Case 1

An expatriate downloads the client (e.g., as a mobile application) for the international call system, and then validates a local SIM card by entering the phone number assigned to the local SIM card into the client. The expatriate will then receive a PIN code sent via text message to the number entered as belonging to the local SIM card. The expatriate then enters the PIN code into the client when prompted to complete the validation process.

The expatriate then adds one or more contacts using the client supported by the international call system by tapping a button labeled “+” in the top right of the screen, selecting one of the contacts via a contact selection tool (e.g., contacts may be populated by the native contacts application residing on the mobile phone), and then selecting a specific phone number to use for that contact.

The expatriate can dial the contact by tapping the name of the contact on the home screen of the client. The expatriate may repeat the process to add as many contacts as desired and call those contacts at any point in time. Moreover, contacts may be able to call the expatriate back at any time using the number they received a call from the expatriate on.

When the expatriate returns to his country of origin, the expatriate can swap the SIM card for a local one, validate the new local SIM card using the client, and cheaply call (and be called by) contacts in their adopted nation(s).

C. Secondary Use Case 2

A child of immigrant parents wishes to stay in touch with his grandmother abroad. The grandchild logs into a client managed by an international call system and validates a home phone number via an automated confirmation call that delivers a PIN code via voice message. The grandchild enters the PIN code into the client (e.g., a web-based interface or application) to complete the phone number validation process.

The grandchild then adds the grandmother as a contact by clicking an icon labeled “+” on the client interface and entering the grandmother's phone number with a country code (e.g., in E.164 format). Upon entering the grandmother as a contact, the client displays both the phone number local to the grandchild that he can use to dial the grandmother, as well as the number local to the grandmother that she can use to call the grandchild.

The grandchild could then email this phone number to the grandmother, who promptly calls the grandchild and may proceed to call him daily. The grandchild is also able to return the grandmother's calls instantly whenever the calls are disconnected. The grandmother (or the grandchild) could create similar call bridges for any other grandchildren, though each grandchild will typically be associated with a separate user account for the international call system.

D. Secondary Use Case 3

A goods importer seeks to maintain a local presence in the country from which the goods are imported. The importer logs into the client and validates a business phone number via an automated confirmation call that delivers a PIN code via a voice message. The importer enters the PIN code into the client to complete the phone number validation process.

The importer can then add a supplier as a contact by clicking an icon labeled “+” on the client interface and entering the supplier's phone number with a country code. Upon entering the supplier as a contact, the client can display both the number local to the importer that can be used to dial the supplier and the number local to the supplier that can be used to dial the importer. The importer then emails one or both of these numbers to the supplier so that they can maintain a normal back and forth calling relationship.

When the importer visits the supplier's country, the importer can swap the SIM card for a local one, validate the new local SIM card, and then use the international call system to appear to still be using the same number previously used to call the supplier from the importer's country.

E. Secondary Use Case 4

A non-profit specializing in humanitarian relief in environmental crises seeks to create call bridges for those affected in an emergency. The non-profit creates a website for gathering the phone numbers of loved ones in peril from their relatives, as well as the relatives' phone numbers. Through the API module residing on the application server of the international call system, bridge numbers can be generated for each side and both parties can receive emails that include contact information for the bridge. Additionally, the international call system could create bridge numbers for relief effort workers and/or residents in peril. Those affected by the crises are now able to call and be called by loved ones, as are those orchestrating the relief efforts.

F. Secondary Use Case 5

A Brazilian resident wishes to call another Brazilian resident living in a different Brazilian province. Because long distance charges apply to Brazilians in inter-province calls, dialing a local provincial number will save on long distance fees.

The Brazilian can download the client (e.g., a mobile application) and then validate the local SIM card installed within the Brazilian's mobile phone through the client. The Brazilian then adds contacts in other countries, as well as other Brazilian provinces, via the client. The Brazilian can call the contacts, and the contacts can call the Brazilian back, with the international call system enabling a local call for both parties regardless of their country or province.

### Processing System

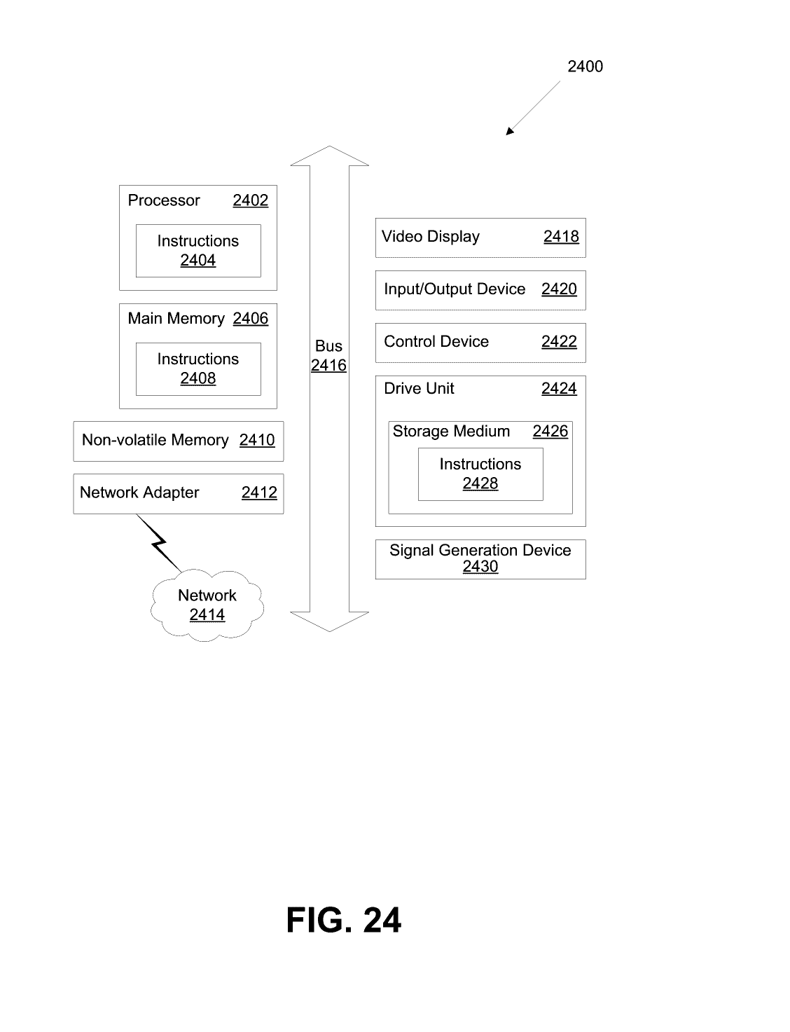

FIG. 24 is a block diagram illustrating an example of a processing system 2400 in which at least some operations described herein can be implemented. The processing system may include one or more central processing units (“processors”) 2402, main memory 2406, non-volatile memory 2410, network adapter 2412 (e.g., network interfaces), video display 2418, input/output devices 2420, control device 2422 (e.g., keyboard and pointing devices), drive unit 2424 including a storage medium 2426, and signal generation device 2430 that are communicatively connected to a bus 2416. The bus 2416 is illustrated as an abstraction that represents any one or more separate physical buses, point to point connections, or both connected by appropriate bridges, adapters, or controllers. The bus 2416, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the processing system 2400 operates as a standalone device, although the processing system 2400 may be connected (e.g., wired or wirelessly) to other machines. In a networked deployment, the processing system 2400 may operate in the capacity of a server or a client machine in a client-server network environment, or as a peer machine in a peer-to-peer (or distributed) network environment.

The processing system 2400 may be a server computer, a client computer, a personal computer (PC), a user device, a tablet (e.g., an Apple iPad), a laptop computer, a personal digital assistant (PDA), a mobile phone (e.g., an Apple iPhone), a processor, a telephone, a web appliance, a network router, switch, or bridge, a console, a hand-held console, a (hand-held) gaming device, a music player, a network-connected wearable device (e.g., a watch), or any machine capable of executing a set of instructions (sequential or otherwise) that specify actions to be taken by the computing system.

While the main memory 2406, non-volatile memory 2410, and storage medium 2426 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 2428. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 2404, 2408, 2428) set at various times in various memory and storage devices in a computer, and that, when read and executed by one or more processing units or processors 2402, cause the processing system 2400 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 2410, floppy and other removable disks, hard disk drives, optical disks (e.g., Compact Disk Read-Only Memory (CD ROMS), Digital Versatile Disks, (DVDs)), and transmission type media such as digital and analog communication links.

The network adapter 2412 enables the computing system 2400 to mediate data in a network 2414 with an entity that is external to the computing device 2400, through any known and/or convenient communications protocol supported by the processing system 2400 and the external entity. The network adapter 2412 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 2412 can include a firewall that can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

### Example Code

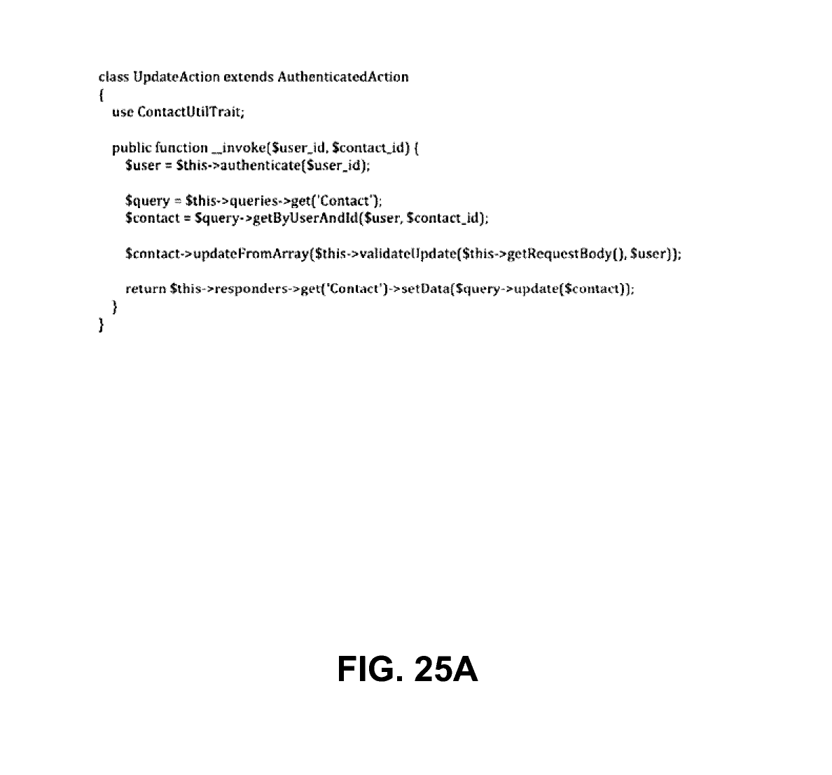

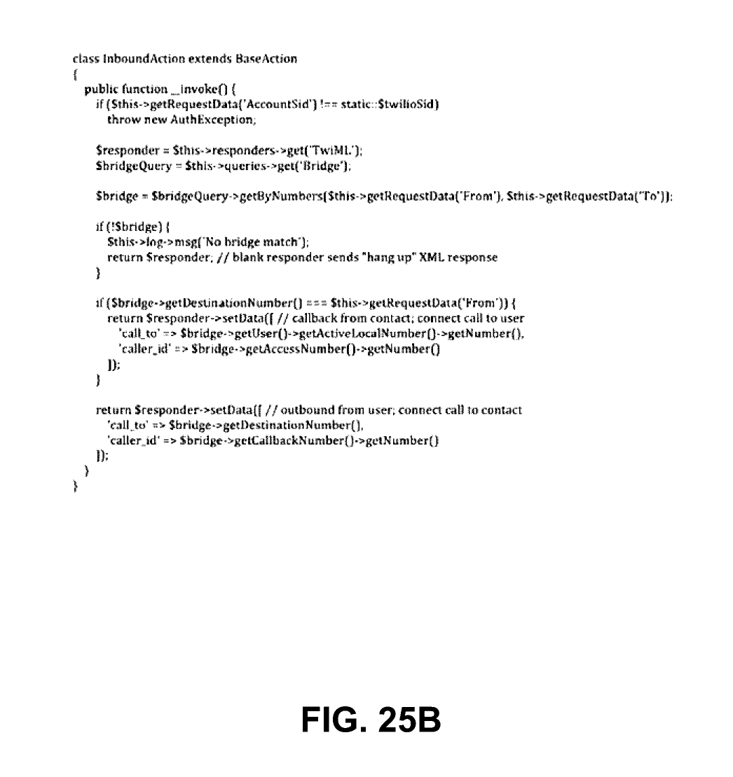

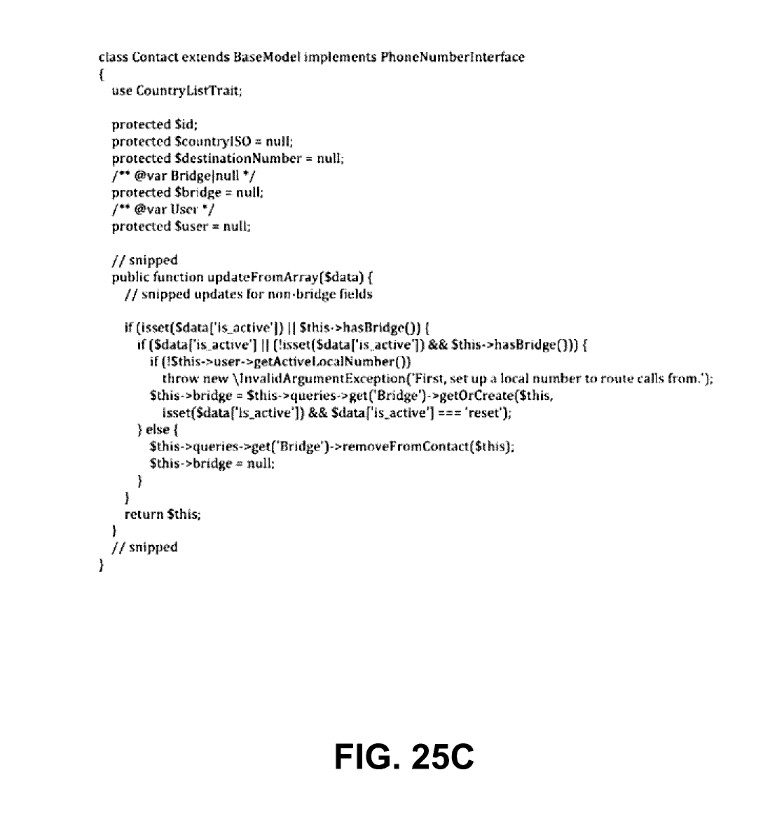

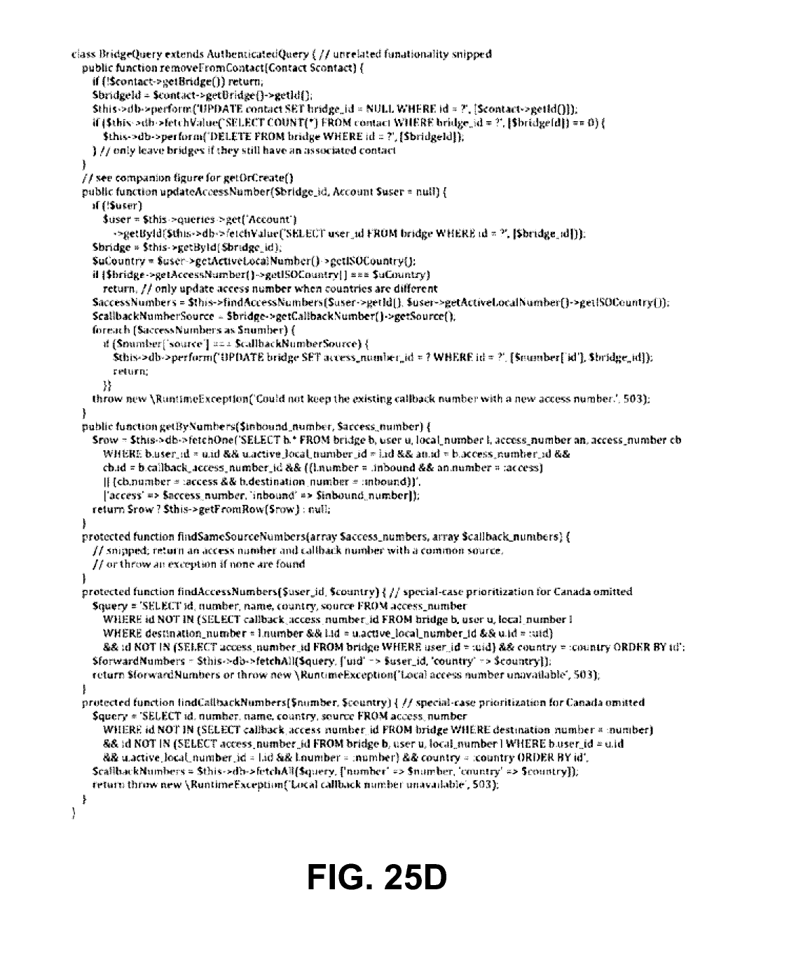

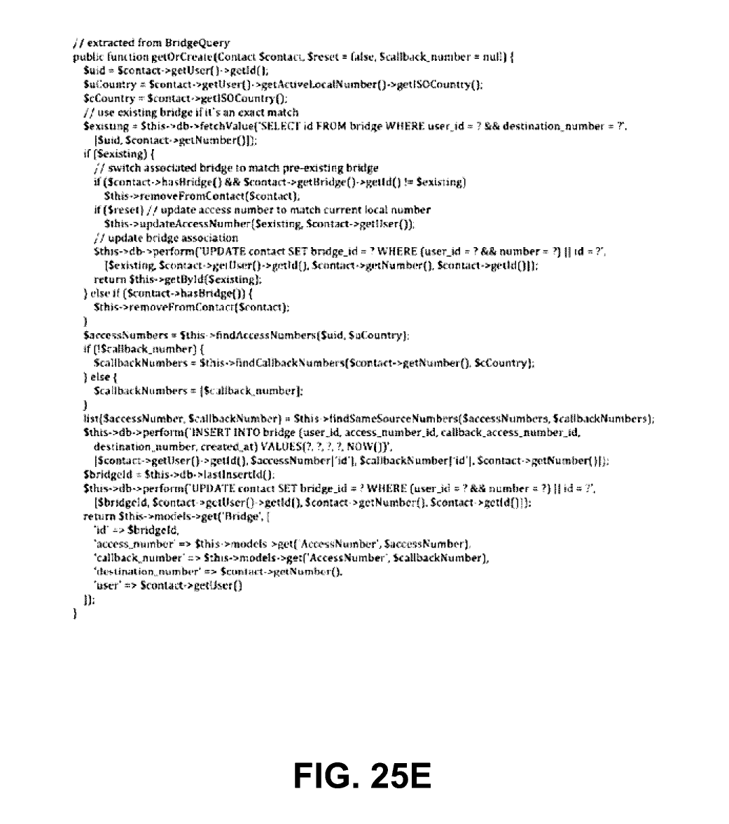

FIGS. 25A-E provide selections of example PHP code for the API module supporting the operation of the application server. The sum of these figures does not represent the entirety of the application server's code base. However, it highlights some key aspects of that code base. Much of the code shown in the figures corresponds to actions taken in FIGS. 19A-E, FIG. 21, and FIG. 22. One skilled in the art will recognize that FIGS. 25A-E depict a single example of PHP code and that the same or similar effects could be realized using other coding structures, languages, etc.

FIG. 25A details the Contact UpdateAction HTTP endpoint. When an HTTP message is sent to this endpoint, _invoke( ) is called. The application server first authenticates the user, throwing an exception and returning an error response if the user credentials are not valid, then retrieves the requested contact in preparation for updating it. Next, the contact is updated based on an array representation of the incoming HTTP request body, which the preferred embodiment expects in JSON format. This update calls the contact model, as further described in FIG. 25C. Finally, the updated contact is handed off to a response builder class, which builds an HTTP response from the object that gets sent over the wire back to the client.

FIG. 25B details the InboundAction HTTP endpoint, which handles notifications from the VoIP services API module of inbound calls and whose responses determine how those calls are dispatched by the voice provider. When an HTTP message is sent to this endpoint, _invoke( ) is called. The application server first authenticates the request to ensure it is genuinely from the voice provider, throwing an exception and returning an error response if the credentials are not valid. Next, the response writer object and bridge query (as further described in FIGS. 25D-E) are instantiated for later use. Next, the bridge query object is queried for bridges matching the number called and the caller ID supplied based on the inbound HTTP request. If no bridge is found, the response writer is returned as-is, which results in a “hang up” HTTP response being sent to the VoIP services API module. If a bridge is found, based on whether the inbound call was from the contact associated with that bridge or the user associated with that bridge, the phone number to contact and the caller ID to display is determined, then passed to the response writer. The response writer uses this data to format a response, which is encoded using XML in the preferred embodiment, that directs the voice services API to connect the other half of the bridged call. The HTTP interaction this code powers is diagrammed in FIG. 21.

FIG. 25C details the contact model's interaction with the Contact UpdateAction HTTP endpoint (FIG. 25A) and BridgeQuery (FIGS. 25D-E). After processing other fields included in the update, the contact's updateFromArray( ) method checks to see if the user is requesting a new or updated bridge, or if they wish to remove a currently enabled bridge. If the latter, the bridge query is instructed to remove the bridge and the internal representation of the contact is updated to reflect this. If the former, the user is checked to ensure they have a valid, active local number (e.g. a local SIM card) associated, throwing an exception that gets converted to a well-formed HTTP error if this check fails. If the check succeeds, the bridge query is used to set up or update the bridge based on a user input, and the contact's internal representation is updated with the newly created or updated bridge. Finally, the contact object is returned as a convenience for method chaining etc. Bridge-related actions taken here are described as part of FIGS. 19A-E.

FIG. 25D details the majority of the key components of BridgeQuery, the business logic class responsible for determining how to create and update bridges, as well as how to resolve input data into the appropriate bridge if one exists. The getOrCreate( ) method has been extracted into FIG. 25E. A more detailed description of the methods found in BridgeQuery follows.

Given a contact, removeFromContact( ) disassociates any bridge currently associated with that contact (if one exists), and decommissions the bridge entirely if that contact was the only one using the bridge (as opposed to two contacts with the same user and destination number sharing a bridge). updateAccessNumber( ) attempts to realign a bridge's access number to the user's currently active local number, as described in FIG. 19B. Given an inbound (caller ID) number and an access (dialed) number, getByNumbers( ) returns a bridge that matches that information, as further described in FIG. 22. The logic for findSameSourceNumbers( ) is described in FIG. 19C. findAccessNumbers( ) attempts to find one or more phone numbers suitable for use as an access number for a new or updated bridge, given a user ID and the preferred country for the access number; FIG. 19D describes this process, including country-specific or region-specific number prioritization that has been omitted here. findCallbackNumbers( ) attempts to find one or more phone numbers suitable for use as a callback number (i.e., from contact to user) for a new bridge, given a destination number and the preferred country for the callback number; FIG. 19E further describes this process, including country-specific or region-specific number prioritization omitted here.

FIG. 25E contains the getOrCreate( ) method of BridgeQuery, which is responsible for determining whether to create a new bridge from a user to a contact, return a pre-existing bridge without modification, or update an existing bridge with a new access number local to the user's new location. This method utilizes several of the methods described above to serve its purpose, in addition to interacting directly with the database to create or update associated contact and bridge records. This method, and those it calls, represent the many aspects of the bridge creation flow described in FIGS. 19A-E.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling others skilled in the relevant art to understand the claimed subject matter, the various embodiments, and the various modifications that are suited to the particular uses contemplated.

Although the above Detailed Description describes certain embodiments and the best mode contemplated, no matter how detailed the above appears in text, the embodiments can be practiced in many ways. Details of the systems and methods may vary considerably in their implementation details, while still being encompassed by the specification. As noted above, particular terminology used when describing certain features or aspects of various embodiments should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless those terms are explicitly defined herein. Accordingly, the actual scope of the invention encompasses not only the disclosed embodiments, but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of various embodiments is intended to be illustrative, but not limiting, of the scope of the embodiments, which is set forth in the following claims.

1. A computer-implemented method for routing calls between users of an international call system, the method comprising:
receiving, at a client residing on a first computing device associated with a user located in a first country, a first user input indicative of a request to place a call to a second computing device associated with a contact located in a second country;
sending, by the client to a phone application residing on the first computing device, an inter-process message that causes the phone application to place a call to an access number associated with the contact,
wherein the call is routed to a first gateway over a Public Switched Telephone Network (PSTN);
causing the first gateway to send a first message to a call processing system across an Internet Protocol (IP) network;
responsive to receiving the first message from the first gateway,
retrieving a destination number for the contact from an application server;
sending the first message to a second gateway over the IP network; and
causing the second gateway to place a call to the destination number that is received by a phone application executing on the second computing device associated with the contact.

2. The computer-implemented method of claim 1, wherein the access number for the contact is for the first country, and wherein the destination number for the contact is for the second country.

3. The computer-implemented method of claim 1, wherein the first and second gateways are Voice over Internet Protocol (VoIP) gateways.

4. The computer-implemented method of claim 1, further comprising:
retrieving a callback number for the user from the application server; and
causing the callback number to be presented as a caller ID when the call is received by the phone application executing on the second computing device associated with the contact.

5. The computer-implemented method of claim 4, wherein the callback number for the user is for the second country.

6. The computer-implemented method of claim 4, further comprising:
responsive to receiving a second message from the second gateway indicative of a selection of the callback number by the contact,
retrieving an active local number for the user from the application server;
sending the second message to the first gateway over the IP network; and
causing the first gateway to place a call to the active local number over the PSTN, wherein the call is received by the phone application executing on the first computing device associated with the user.

7. The computer-implemented method of claim 6, further comprising:
presenting the access number of the contact as a caller ID when the call is received by the phone application executing on the first computing device associated with the user.

8. The computer-implemented method of claim 6, wherein the access number is temporarily assigned to the contact by the call processing system, and wherein the callback number is temporarily assigned to the user by the call processing system.

9. The computer-implemented method of claim 6, wherein the access number is permanently assigned to the contact by the call processing system, and wherein the callback number is permanently assigned to the user by the call processing system.

10. A call processing system for routing calls between users located in different countries, the call processing system comprising:
a processor operable to execute instructions stored in a machine-readable data storage; and
the machine-readable data storage that includes libraries of active local numbers, access numbers, destination numbers, callback numbers, or a combination thereof, wherein the specific instructions cause the processor to perform operations including:
receiving a message from a first gateway across an Internet Protocol (IP) network,
wherein the message is transmitted by the first gateway responsive to receiving a call from a first mobile phone of a user located in a first country who intends to communicate with a contact in a second country, and
wherein the call is placed to an access number for the first country that is associated with the contact;
retrieving a destination number for the contact from an application server,
wherein the destination number is for the second country;
modifying the message to include the destination number;
sending the modified message to a second gateway over the IP network; and
causing the second gateway to place a call to the destination number that is received by a phone application executing on a second mobile phone associated with the contact.

11. The call processing system of claim 10, wherein the call is placed by the first mobile phone to the first gateway over a Public Switched Telephone Network (PSTN).

12. The call processing system of claim 10, wherein the calls placed by the first mobile phone to the first gateway using the access number and by the second gateway to the second mobile phone using the destination number are local calls.

13. The call processing system of claim 10, wherein the each of the active local numbers, access numbers, destination numbers, and callback numbers in the machine-readable data storage are stored in an E.164 format.

14. The call processing system of claim 10, further comprising:
a connection logic service module that is executable by the processor and that maintains a mapping of access numbers to destination numbers and a mapping of callback numbers to active local numbers.

15. The call processing system of claim 10, wherein the operations further include:
creating a bridge data structure that links an active local number and a callback number associated with the user to the destination number and the access number associated with the contact,
wherein the bridge data structure is used by the processor to route calls between the user and the contact.

16. A method of creating a call bridge for routing calls between users located in different countries, the method comprising:
receiving a user input indicative of a request input by a user at a client residing on a first computing device to create a call bridge between the user and a contact,
wherein the user is located in a first country and the contact is located in a second country;
acquiring an access number and a destination number for the contact from a database,
wherein the access number is usable within the first country and
the destination number is usable within the second country;
linking the access number and the destination number in a bridge data structure for use in subsequent calls placed by the user to the contact; and
storing the bridge data structure in the database.

17. The method of claim 16, further comprising:
acquiring a callback number and an active local number for the user from the database; and
linking the callback number and the active local number in the bridge data structure for use in subsequent calls placed by the contact to the user.

18. The method of claim 16, further comprising:
transmitting the bridge data structure to the client residing on the first computing device for use in subsequent calls initiated by the user.

19. The method of claim 17, wherein the active local number is associated with a SIM card installed within the first computing device of the user, and wherein the destination number is associated with a SIM card installed within a second computing device of the contact.

20. The method of claim 17, wherein the active local number is usable within the first country and the callback number is usable within the second country.
